(19) United States
(12) Patent Application Publication
(10) Pub. No.: US 2026/0106382 A1
(43) Pub. Date: Apr. 16, 2026

(54) VEHICULAR ANTENNA HAVING A LOW-PROFILE ANTENNA ASSEMBLY FOR NON-METAL SURFACE AND METAL SURFACE APPLICATION

(71) Applicant: TE Connectivity Solutions GmbH, Schaffhausen (CH)

(72) Inventors: KokJiunn NG, Prai (MY); Poi Ngee TAN, Prai (MY); TingHee LEE, Prai (MY); Keanmeng LIM, Prai (MY)

(21) Appl. No.: 19/303,501

(22) Filed: Aug. 19, 2025

Related U.S. Application Data
(60) Provisional application No. 63/707,850, filed on Oct. 16, 2024.

(51) Int. Cl. H01Q 21/28; H01Q 1/32; H01Q 1/42; H01Q 1/48; H01Q 21/06

(52) U.S. Cl. CPC H01Q 21/28; H01Q 1/3208; H01Q 1/48; H01Q 21/061; H01Q 1/42

(57) ABSTRACT

A vehicular antenna includes a low-profile housing having a first end and a second end and having a first side and a second side. An antenna assembly is provided in the low-profile housing. The antenna assembly includes a first cellular antenna at the first end and a second cellular antenna at the second end. The antenna assembly includes a first ground element at the first side and a second ground element at the second side. The first cellular antenna is operably coupled to the first ground element and the second cellular antenna is operably coupled to the second ground element. The first ground element is isolated from the second ground element

### CROSS REFERENCE TO RELATED APPLICATIONS

This application claims benefit to U.S. Provisional Application No. 63/707,850, filed 16 Oct. 2024, titled “VEHICULAR ANTENNA HAVING A LOW-PROFILE ANTENNA ASSEMBLY FOR NON-METAL SURFACE AND METAL SURFACE APPLICATION”, the subject matter of which is herein incorporated by reference in its entirety.

### BACKGROUND OF THE INVENTION

The subject matter herein relates generally to low-profile antenna assemblies for non-metal surface and metal surface applications.

Antennas are used in communication system to transmit and receive electromagnetic waves and are used in many applications. For example, in vehicular applications, antennas are essential components of vehicles that enable wireless communication and entertainment. The vehicular antennas are used for a variety of purposes including radio reception to receive AM and FM radio signals, GPS navigation to receive signals from GPS satellites to determine the vehicle's location, Wi-Fi connectivity to create a Wi-Fi hotspot for passengers, Bluetooth connectivity to facilitate Bluetooth connectivity of devices, vehicle-to-everything (V2X) communication to enable communication between the vehicle and the surrounding environment including other vehicles and the network, autonomous vehicle communication to transmit and receive radio frequency (RF) signals between vehicles and infrastructure for collision avoidance, traffic management, and real-time navigation, and the like.

Various types of vehicular antennas are utilized, such as cellular antennas, Wi-Fi antennas, GNSS antennas, satellite communication antennas, and the like. There is a desire to incorporate multiple antennas into a single antenna assembly, such as for convenience of assembly. However, incorporating multiple antennas into a single assembly leads to problems with operation of the individual antenna elements and there is a need to maintain isolation between the antenna elements. For example, antenna radiation patterns may be degraded and lower down the antenna efficiency by the adjacent antenna elements. There is also a demand for such multi-antenna assemblies to keep a low-profile and small footprint, further leading to limiting performance where antenna optimization and isolation is difficult to achieve. Low band antenna efficiency remain low, especially at the low band, when the antenna is low-profile and small due to space constraints. For example, it is challenging to efficiently design small and low-profile antenna elements for the lowest operating frequency (e.g. at 617 MHz) and with isolation better than 10 dB. low-profile

Additionally, the antenna mounting location may be important for proper operation of the antenna elements. For example, the antenna may be designed to operate at a particular location on the vehicle and mounting at other locations may negatively affect operation of the antenna element. For example, some antennas are designed to be mounted on metal surfaces, such as the rooftop or panels of the vehicle, for proper operation whereas other antennas are designed to be mounted on non-metal surfaces, such as plastic, glass, fiberglass reinforced plastic, and the like such as for a windshield, window, dashboard, fiberglass roof, of the vehicle for proper operation. Mounting of the antenna elements on the incorrect mounting surfaces may lead to significant performance degradation.

Monopole type antennas are popular in the vehicular type antenna in the form of PCB or stamping part for rooftop or metal surface application. However, such monopole antenna type antenna typically requires a high profile height. PIFA and shorted monopole type antennas are typically used for lower profile applications. However, such antennas still need a certain height and size to achieve reasonably good performance and still may have variation performance between mounted on a metal surface versus a non-metal surface. Conventional PIFA antenna have limited bandwidth. MIMO antenna and multi antenna in compact size may limit the antenna performance in term of isolation and radiation pattern. Wi-Fi radiation patterns may be distorted by other elements leading to high ripple at the horizontal plane and low average gain. Ultra-low-profile antennas are typically planar dipole type of antennas and applied only on non-metal surface. Such antennas have significant performance degradation and detuning if applied on top of the metal-surface as dipole antenna need quite a certain height to be functional without impact of detuning or performance degradation.

There is a need for a low-profile and small antenna capable of being mounted on both a metal surface or a nonmetal surface (e.g. glass or plastic) with minimal detuning of the antenna or degradation of the performance in desired frequency ranges, such as at low frequency e.g. the frequency of 617-960 MHz for LTE applications.

### BRIEF DESCRIPTION OF THE INVENTION

In an embodiment, a vehicular antenna is provided including a low-profile housing having a first end and a second end and having a first side and a second side. An antenna assembly is provided in the low-profile housing. The antenna assembly includes a first cellular antenna at the first end and a second cellular antenna at the second end. The antenna assembly includes a first ground element at the first side and a second ground element at the second side. The first cellular antenna is operably coupled to the first ground element and the second cellular antenna is operably coupled to the second ground element. The first ground element is isolated from the second ground element.

In one embodiment, a vehicular antenna is provided and includes a low-profile housing that has a first end and a second end. The low-profile housing has a first side and a second side. The vehicular antenna includes an antenna assembly in the low-profile housing. The antenna assembly includes a first cellular antenna at the first end and a second cellular antenna at the second end. The antenna assembly includes a first ground element at the first side and a second ground element at the second side. The first cellular antenna operably coupled to the first ground element. The second cellular antenna operably coupled to the second ground element. The first ground element isolated from the second ground element.

In another embodiment, a vehicular antenna is provided and includes a low-profile housing that has a first end and a second end. The low-profile housing has a first side and a second side. The vehicular antenna includes an antenna assembly in the low-profile housing. The antenna assembly includes a first cellular antenna at the first end, a second cellular antenna at the second end, a first ground element at the first side, and a second ground element at the second side. The first cellular antenna includes a first patch panel and a first tapered feed extending from the first patch panel. The first tapered feed is operably coupled to the first ground element. The second cellular antenna includes a second patch panel and a second tapered feed extending from the second patch panel. The second tapered feed is operably coupled to the second ground element. The first ground element has a first tapered edge tapered between a first connecting end and a first distal end. The first connecting end located below the first patch panel and is operably coupled to the first tapered feed. The first distal end is located below the second patch panel. The second ground element has a second tapered edge tapered between a second connecting end and a second distal end. The second connecting end is located below the second patch panel and is operably coupled to the second tapered feed. The second distal end is located below the second patch panel. The first tapered edge faces the second tapered edge across a ground gap. The first ground element is isolated from the second ground element across the ground gap.

In a further embodiment, a vehicular antenna is provided and includes a low-profile housing that has a first end and a second end. The low-profile housing has a first side and a second side. The vehicular antenna includes an antenna assembly in the low-profile housing. The antenna assembly includes a first cellular antenna at the first end, a second cellular antenna at the second end, a first Wi-Fi antenna at the first side between the first and second cellular antennas, a second Wi-Fi antenna at the second side between the first and second cellular antennas, and a Bluetooth antenna at the second side between the first and second cellular antennas. The antenna assembly includes a first ground element at the first side and a second ground element at the second side. The first cellular antenna operably coupled to the first ground element. The second cellular antenna operably coupled to the second ground element. The first ground element isolated from the second ground element.

### BRIEF DESCRIPTION OF THE DRAWINGS

FIG. 1 illustrates an example of a vehicle having a vehicular antenna in accordance with an exemplary embodiment.

FIG. 2 illustrates another example of a vehicle having the vehicular antenna in accordance with an exemplary embodiment.

FIG. 3 is a perspective view of the vehicular antenna in accordance with an exemplary embodiment.

FIG. 4 is a side view of the vehicular antenna accordance with an exemplary embodiment.

FIG. 5 is an exploded view of the vehicular antenna in accordance with an exemplary embodiment.

FIG. 6 is a perspective view of the vehicular antenna in accordance with an exemplary embodiment.

FIG. 7 is a side view of the vehicular antenna 100 accordance with an exemplary embodiment.

FIG. 8 is an exploded view of the vehicular antenna shown in FIGS. 6-7 in accordance with an exemplary embodiment.

FIG. 9 is a schematic view of the antenna assembly in accordance with an exemplary embodiment.

FIG. 10 is a schematic view of the antenna assembly in accordance with an exemplary embodiment.

FIG. 11 is a schematic view of the antenna assembly in accordance with an exemplary embodiment.

FIG. 12 is a schematic view of the antenna assembly in accordance with an exemplary embodiment.

FIG. 13 is an exploded view of a portion of the vehicular antenna in accordance with an exemplary embodiment.

FIG. 14 is an exploded view of a portion of the vehicular antenna in accordance with an exemplary embodiment.

FIG. 15 is a top view of the first cellular antenna in accordance with an exemplary embodiment.

FIG. 16 is an end view of the first cellular antenna in accordance with an exemplary embodiment.

FIG. 17 is a side view of the first cellular antenna in accordance with an exemplary embodiment.

FIG. 18 is a perspective view of a portion of the vehicular antenna showing the antenna assembly coupled to the base in accordance with an exemplary embodiment.

FIG. 19 is a top perspective view of a portion of the vehicular antenna showing the antenna assembly coupled to the base in accordance with an exemplary embodiment.

FIG. 20(a)-(g) illustrate alternative shapes for the cellular antenna elements in accordance with an exemplary embodiment.

FIG. 21 is a top view of a portion of the vehicular antenna in accordance with an exemplary embodiment.

FIG. 22 is a front view of a portion of the vehicular antenna in accordance with an exemplary embodiment.

FIG. 23 is a perspective view of a portion of the vehicular antenna in accordance with an exemplary embodiment.

FIG. 24 illustrates a portion of the vehicular antenna in accordance with an exemplary embodiment.

FIG. 25 illustrates a portion of the vehicular antenna in accordance with an exemplary embodiment.

FIG. 26(a)-(f) illustrate alternative arrangements of the parasitic radiating elements in accordance with alternative embodiments.

FIG. 27 illustrates the antenna assembly in accordance with an exemplary embodiment.

FIG. 28 illustrates a top perspective view of a portion of the antenna assembly in accordance with an exemplary embodiment.

FIG. 29 illustrates an exploded view of a portion of the antenna assembly in accordance with an exemplary embodiment.

FIG. 30 illustrates the antenna assembly in accordance with an exemplary embodiment.

FIG. 31 illustrates the antenna assembly in accordance with an exemplary embodiment.

FIG. 32 illustrates a top perspective view of a portion of the antenna assembly in accordance with an exemplary embodiment.

FIG. 33 illustrates an exploded view of a portion of the antenna assembly in accordance with an exemplary embodiment.

FIG. 34 is a chart showing efficiency performance summary of the cellular antenna elements of the antenna assembly.

FIG. 35 is a chart showing isolation between the first and second cellular antennas of the antenna assembly.

FIG. 36 is a chart showing isolation between the first cellular antenna and the first and second Wi-Fi antennas of the antenna assembly.

FIG. 37 is a chart showing efficiency performance summary of the cellular antenna elements of the antenna assembly.

FIG. 38 shows the antenna radiation patterns at the low band for the antenna assembly in the non-metal mounting configuration.

FIG. 39 shows the antenna radiation patterns at the mid band for the antenna assembly in the non-metal mounting configuration.

FIG. 40 shows the antenna radiation patterns at the high band for the antenna assembly in the non-metal mounting configuration.

FIG. 41 is a chart showing efficiency performance summary of the Wi-Fi antenna elements of the antenna assembly.

FIG. 42 is a chart showing average gain at Azimuth of the Wi-Fi antenna elements of the antenna assembly.

FIG. 43 shows the antenna radiation patterns of the Wi-Fi antenna elements of the antenna assembly.

FIG. 44 is a side view of a portion of the vehicular antenna in accordance with an exemplary embodiment.

FIG. 45 is a top view of a portion of the vehicular antenna in accordance with an exemplary embodiment.

FIG. 46 is an end view of a portion of the vehicular antenna in accordance with an exemplary embodiment.

FIG. 47 is a perspective view of a portion of the vehicular antenna in accordance with an exemplary embodiment.

### DETAILED DESCRIPTION OF THE INVENTION

The subject matter herein provides embodiments of an antenna assembly of a vehicular antenna. In an exemplary embodiment, the antenna assembly is a low-profile and small size antenna which offers improved cellular low band performance & isolation. In an exemplary embodiment, the antenna assembly is able to operate at both non-metal and metal surface without significant performance degradation or variation particularly on the antenna total efficiency. In an exemplary embodiment, the antenna assembly includes an improved average azimuth gain Wi-Fi antenna. The Wi-Fi antenna may be less affected by the ground of the cellular antenna or metal surface that make the Wi-Fi performance more consistent.

In an exemplary embodiment, the antenna assembly presents a low-profile antenna assembly which has an extended ground plane allowing the antenna to have a wide band and miniatured size. The ground plane offers the antenna with minimal impact towards application in both a non-metal surface or on a large metal surface. In an exemplary embodiment, the antenna assembly includes cellular antennas that adopt one or more PIFA elements with an asymmetrical tapering feed to increase electrical length while maintaining small physical size to improve low band performance. In an exemplary embodiment, the antenna assembly includes a double layer PCB acting as the ground plane with a strategically placed single or multiple plated through hole (PTH) via connecting the top and bottom layer. This configuration extends the length of ground plane and widens the antenna operating bandwidth. In an exemplary embodiment, the ground planes are separated allowing multiple cellular antennas to be placed in rotated conditions to have a 2×2 MIMO configuration, a 4×4 MIMO configuration, a 6×6 MIMO configuration, and the like. This condition improves the low-profile antenna but also the isolation between the cellular antenna significantly for its length or distance between the two elements. In an exemplary embodiment, the cellular antennas of the antenna assembly are very low-profile for their lowest frequency of 617 MHz. The radiating element has full potential operating from 617-7125 MHz. In an exemplary embodiment, for further improvement on the input impedance and the efficiency of the antenna, the antenna is matched with lump components to maximize efficiency.

In an exemplary embodiment, the antenna assembly includes Wi-Fi assemblies, GNSS and other potential application. In an exemplary embodiment, the WI-FI antenna is designed with a suspended shorted monopole antenna with its ground plane above the main ground plane without any galvanized contact. In an exemplary embodiment, the Wi-Fi antennas are placed between the cellular antennas. The WI-FI antennas may be capable of operating for WI-FI 7 covering 2.4-2.5 GHz and 4.9-7.125 GHz. In an exemplary embodiment, the Wi-Fi antenna has a radiation pattern having improved average gain at horizon due to the design environment. The Wi-Fi antenna includes parasitic elements to improve the radiation pattern.

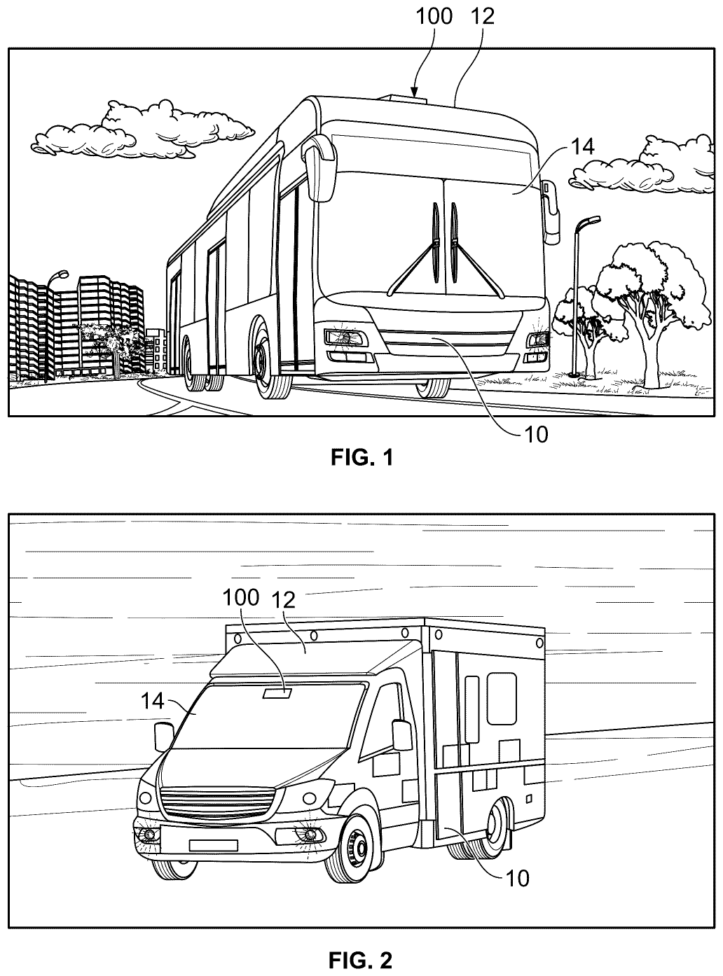

FIG. 1 illustrates an example of a vehicle 10 having a vehicular antenna 100 in accordance with an exemplary embodiment. FIG. 2 illustrates another example of a vehicle 10 having the vehicular antenna 100 in accordance with an exemplary embodiment. FIG. 1 illustrates the vehicle 10 as a bus, such as a public transportation bus. FIG. 2 illustrates the vehicle 10 as an emergency services vehicle, such as an ambulance. The vehicular antenna 100 may be used on other types of vehicles in alternative embodiments, such as passenger vehicles, tractor-trailers, industrial vehicles, farming vehicles, military vehicles, watercraft, aeronautical vehicles, and the like.

FIG. 1 illustrates the vehicular antenna 100 on a conductive surface 12 of the vehicle 10, such as the rooftop of the vehicle 10. FIG. 2 illustrates the vehicular antenna 100 on a non-metal surface 14 of the vehicle 10, such as a windshield, window, dashboard, fiberglass roof, and the like. The vehicular antenna 100 is able to operate as both a free-space antenna device on the nonmetal surface 14 or a metal surface antenna device on the metal surface 12 without significant performance degradation in either configuration, such as on the antenna total efficiency. In an exemplary embodiment, the vehicular antenna 100 is a low-profile and small size antenna device which offers multiband antenna performance, even at a cellular low band frequency, and proper isolation.

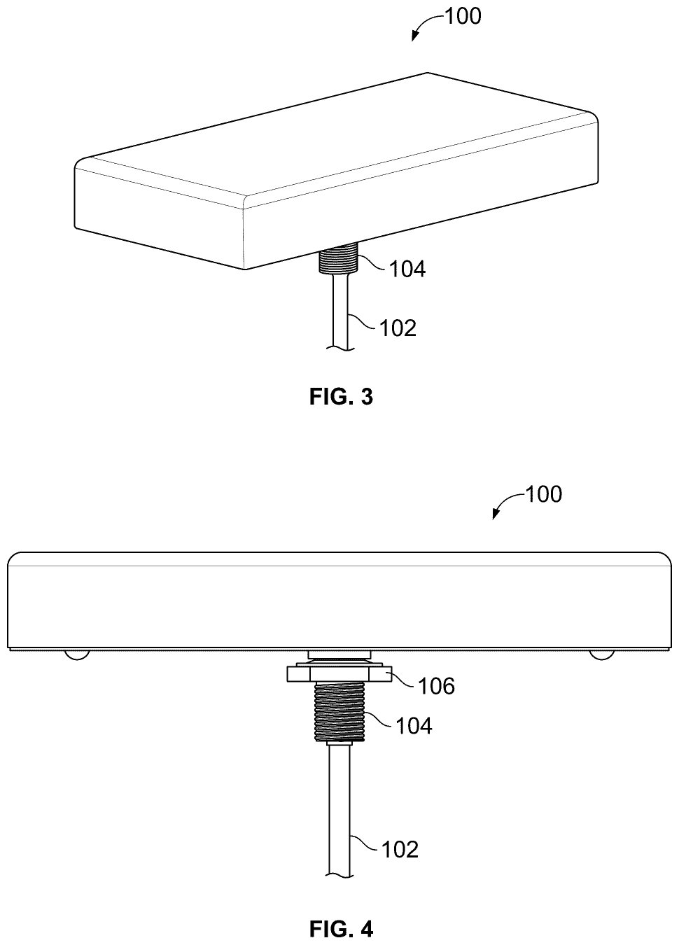

FIG. 3 is a perspective view of the vehicular antenna 100 in accordance with an exemplary embodiment. FIG. 4 is a side view of the vehicular antenna 100 accordance with an exemplary embodiment. FIGS. 3 and 4 illustrate the vehicular antenna 100 as a hard mount antenna device. The vehicular antenna 100 has a cable exit at the bottom of the vehicular antenna 100. A feed cable 102 of the vehicular antenna 100 extends from the cable exit at the bottom. The bottom of the vehicular antenna 100 is configured to be mounted to the vehicle 10, such as the metal surface 12 or the nonmetal surface 14. In the illustrated embodiment, the vehicular antenna 100 includes a threaded mounting lug 104 and a threaded nut 106 used to mount the vehicular antenna 100 to the vehicle 10. Other mounting elements may be used in alternative embodiments to secure the vehicular antenna 100 to the vehicle 10.

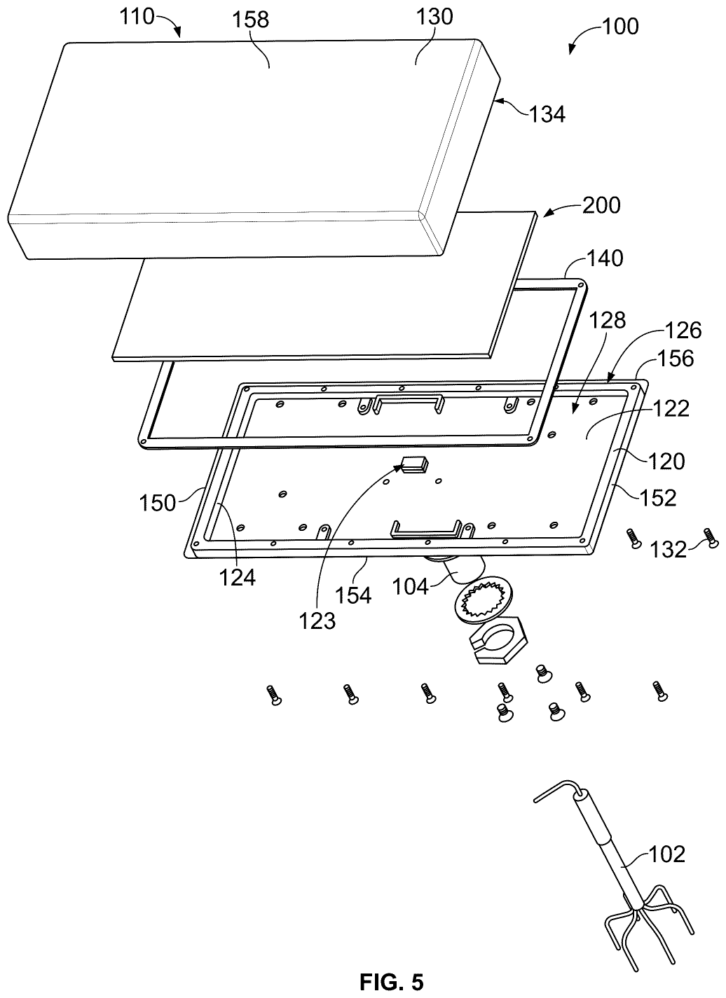

FIG. 5 is an exploded view of the vehicular antenna 100 in accordance with an exemplary embodiment. The vehicular antenna 100 includes a housing 110 configured to hold an antenna assembly 200. The feed cable 102 is configured to be coupled to the housing 110 and is configured to be electrically connected to the antenna assembly 200 within the interior of the housing 110.

In an exemplary embodiment, the housing 110 is a multipiece housing having a base 120 and a radome 130 coupled to the base 120 using fasteners 132. The base 120 includes a bottom plate 122 and walls 124 extending from the bottom plate 122. In an exemplary embodiment, the base 120 includes a seal pocket 126 that receives a peripheral seal 140. The peripheral seal 140 is configured to seal between the base 120 and the radome 130. The walls 124 form an antenna pocket 128 that receives the antenna assembly 200. In an exemplary embodiment, the base 120 is manufactured from a metal material, such as a metal material. In various embodiments, the base 120 is a diecast component. In alternative embodiments, the base 120 is a stamped and formed metal part. In an exemplary embodiment, the base 120 includes an opening 123 at the bottom plate 122 that receives the feed cable 102. The threaded mounting lug 104 is configured to be coupled to the base 120 at the opening 123 and the threaded nut is configured to be threadably coupled to the mounting lug 104 to secure the housing 110 to the vehicle 10.

The radome 130 is configured to cover the antenna assembly 200. In an exemplary embodiment, the radome 130 is manufactured from a dielectric material, such as a plastic material. In various embodiments, the radome 130 may be manufactured from a polycarbonate material. The radome 130 includes walls forming an interior cavity 134 that receives the antenna assembly 200. In an exemplary embodiment, the radome 130 is rectangular shaped. However, the radome 130 may have other shapes in alternative embodiments. In an exemplary embodiment, the radome 130 has a low-profile to form a low-profile vehicular antenna 100.

In an exemplary embodiment, the vehicular antenna 100 extends between a first end 150 and a second end 152. The vehicular antenna 100 extends between a first side 154 and a second side 156. The vehicular antenna 100 is elongated end to end such that the sides 154, 156 are longer than the ends 150, 152. The vehicular antenna 100 includes a top 158 extending between the ends 150, 152 and the sides 154, 156. In the illustrated embodiment, the vehicular antenna 100 is rectangular shaped. The vehicular antenna 100 may have other shapes in alternative embodiments. In an exemplary embodiment, the vehicular antenna 100 has a small form factor, such as having a small footprint and a low-profile. In various embodiments, the ends 150, 152 may be at most 100 mm and the sides 154, 156 may be at most 200 mm. The ends 150, 152 may be longer or shorter in alternative embodiments. The sides 154, 156 may be longer or shorter in alternative embodiments.

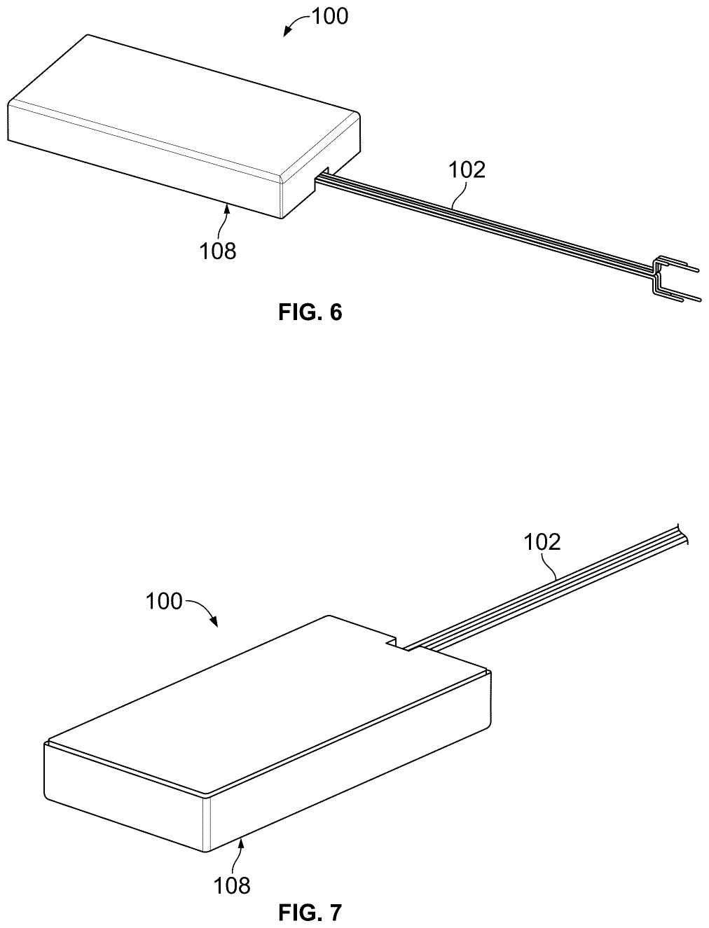

FIG. 6 is a perspective view of the vehicular antenna 100 in accordance with an exemplary embodiment. FIG. 7 is a side view of the vehicular antenna 100 accordance with an exemplary embodiment. FIGS. 6 and 7 illustrate the vehicular antenna 100 as the adhesive mount antenna device. The vehicular antenna 100 has a cable exit at one of the sides, rather than the bottom, of the vehicular antenna 100. The feed cable 102 extends from the cable exit at the side. The bottom of the vehicular antenna 100 is configured to be mounted to the vehicle 10, such as the metal surface 12 or the nonmetal surface 14. In the illustrated embodiment, the vehicular antenna 100 includes an adhesive element 108, such as an adhesive pad, film, or other adhesive layer at the bottom used to mount the vehicular antenna 100 to the vehicle 10. Other mounting elements may be used in alternative embodiments to secure the vehicular antenna 100 to the vehicle 10.

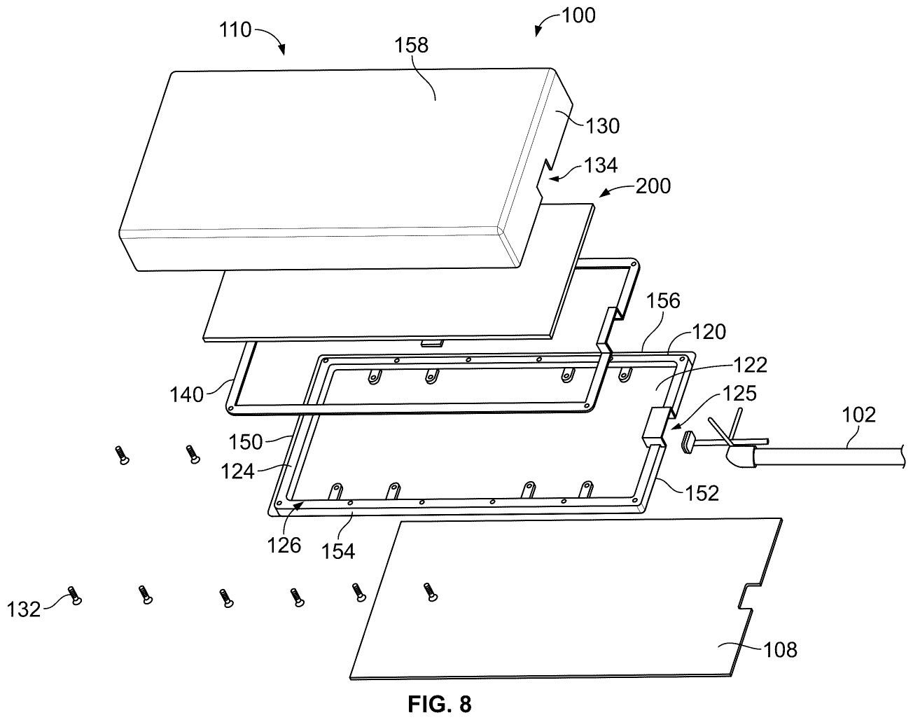

FIG. 8 is an exploded view of the vehicular antenna 100 shown in FIGS. 6-7. The vehicular antenna 100 includes the housing 110 configured to hold the antenna assembly 200. The feed cable 102 is configured to be electrically connected to the antenna assembly 200 within the interior of the housing 110.

In an exemplary embodiment, the housing 110 is a multipiece housing having the base 120 and the radome 130 coupled to the base 120 using fasteners 132. The radome 130 is configured to cover the antenna assembly 200. The radome 130 forms the interior cavity 134 that receives the antenna assembly 200. The base 120 includes the bottom plate 122 and the walls 124 extending from the bottom plate 122. In an exemplary embodiment, the base 120 includes the seal pocket 126 that receives the peripheral seal 140. In an exemplary embodiment, the base 120 includes an opening 125 at the bottom plate 122 that receives the feed cable 102. The opening 125 is located at the side of the base 120. The adhesive element 108 is configured be secured to the bottom plate 122, such as using adhesive.

In an exemplary embodiment, the vehicular antenna 100 extends between the first end 150 and the second end 152. The vehicular antenna 100 extends between the first side 154 and the second side 156. The vehicular antenna 100 includes the top 158 extending between the ends 150, 152 and the sides 154, 156. In the illustrated embodiment, the vehicular antenna 100 is rectangular shaped. The vehicular antenna 100 may have other shapes in alternative embodiments. In an exemplary embodiment, the vehicular antenna 100 has a small form factor, such as having a small footprint and a low-profile.

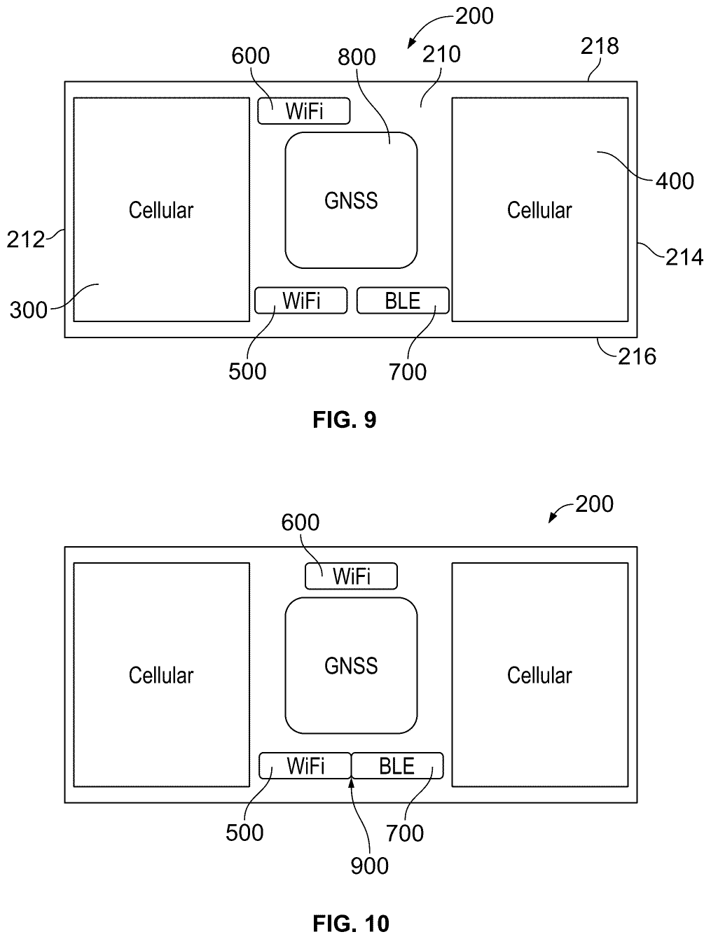

FIG. 9 is a schematic view of the antenna assembly 200 in accordance with an exemplary embodiment. The antenna assembly 200 includes one or more substrates 210 used to support the components of the antenna assembly 200.

In an exemplary embodiment, the substrate 210 is a printed circuit board. The substrate 210 includes a first end 212, a second end 214, a first side 216, and a second side 218. The substrate 210 may be generally rectangular shaped. The substrate 210 may have other shapes in alternative embodiments, such as being circular, triangular, hexagonal, or another shape. In the illustrated embodiment, the substrate 210 is elongated having the sides 216, 218 longer than the ends 212, 214. In an exemplary embodiment, the substrate 210 supports one or more ground elements (not shown) providing an electrical ground for the antenna assembly 200. The ground elements may be circuits, pads, traces, vias, stamped elements, or other types of ground elements.

In an exemplary embodiment, the antenna assembly 200 is a multiband antenna operable in more than one frequency range. For example, the antenna 100 may be operable in multiple different cellular frequency bands and/or in multiple different Wi-Fi frequency bands and/or in one or more Bluetooth frequency bands. For example, in an exemplary embodiment, the antenna 100 is operable at the 700 MHz cellular band and/or the 1700 MHz cellular band and/or the 2100 MHz cellular band and/or other cellular bands. In an exemplary embodiment, the antenna 100 is operable at the 2.4 GHz Wi-Fi band and/or the 5 GHz Wi-Fi band and/or other Wi-Fi bands. In an exemplary embodiment, the antenna 100 is operable at the 2.4 GHz Bluetooth band. In an exemplary embodiment, the antenna 100 can be used for multiple-input and multiple-output (MIMO) communication when having multiple antennas on the device. In an exemplary embodiment, the antenna 100 may have wide high band and/or wide low band antenna pattern control. The antenna 100 may have a wide beam width at the azimuth plane.

In an exemplary embodiment, the antenna assembly 200 includes a first cellular antenna 300, a second cellular antenna 400, a first Wi-Fi antenna 500, a second Wi-Fi antenna 600, a Bluetooth antenna 700, and a GNSS antenna 800. The antenna assembly 200 may include greater or fewer antenna elements in alternative embodiments. In the illustrated embodiment, the first cellular antenna 300 is provided at the first and 212 and the second cellular antenna 400 is provided at the second end 214. The first and second cellular antennas 300, 400 are located at the opposite ends 212, 214 to provide isolation between the cellular antennas 300, 400. In the illustrated embodiment, the first Wi-Fi antenna 500 is provided at the first side 216 and the second Wi-Fi antenna 600 is provided at the second side 218. The first and second Wi-Fi antennas 500, 600 are located between the first and second cellular antennas 300, 400. In the illustrated embodiment, the Bluetooth antenna 700 is provided at the first side 216. The Bluetooth antenna 700 is located between the first and second cellular antennas 300, 400. The GNSS antenna 800 is located between the first and second cellular antennas 300, 400. Other locations for the antenna elements may be provided in alternative embodiments.

FIG. 10 is a schematic view of the antenna assembly 200 in accordance with an exemplary embodiment. The antenna assembly 200 is similar to the antenna assembly shown in FIG. 9. However, the antenna assembly 200 shown in FIG. 10 includes a single antenna element 900 that combines the first Wi-Fi antenna 500 and the Bluetooth antenna 700. For example, the first Wi-Fi antenna 500 and the Bluetooth antenna 700 may operate on a similar frequency range. Combining the first Wi-Fi antenna 500 and the Bluetooth antenna 700 reduces the parts count or components of the antenna assembly 200, which may reduce the cost of the antenna assembly 200. Combining the first Wi-Fi antenna 500 and the Bluetooth antenna 700 may reduce the real estate needed for the antenna elements, allowing a reduction in size of the antenna assembly 200 and/or different sizing/shaping of the antenna elements and/or greater isolation between the antenna elements.

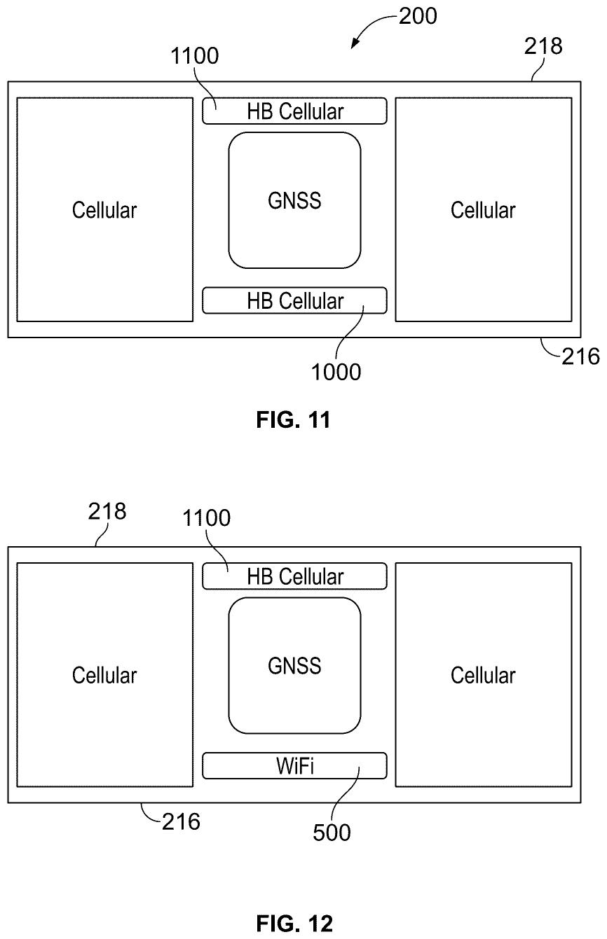

FIG. 11 is a schematic view of the antenna assembly 200 in accordance with an exemplary embodiment. The antenna assembly 200 is similar to the antenna assembly shown in FIG. 9. However, the antenna assembly 200 shown in FIG. 11 includes a first high band cellular antenna 1000 at the first side 216 and a second high band cellular antenna 1100 at the second side 218. The high band cellular antennas 1000, 1100 replace the first and second Wi-Fi antennas 500, 600 and the Bluetooth antenna 700 (shown in FIG. 9). Providing the high band cellular antennas 1000, 1100 allows operation of the antenna assembly 200 in one or more additional cellular frequency bands, such as at the 1.5 GHz to 6 GHz bands.

FIG. 12 is a schematic view of the antenna assembly 200 in accordance with an exemplary embodiment. The antenna assembly 200 is similar to the antenna assembly shown in FIGS. 9 and 11. However, the antenna assembly 200 shown in FIG. 12 includes the second high band cellular antenna 1100 at the second side 218 and the first Wi-Fi antenna 500 at the first side 216. Such an arrangement allows operation of the antenna assembly 200 in the high band cellular range and the Wi-Fi range.

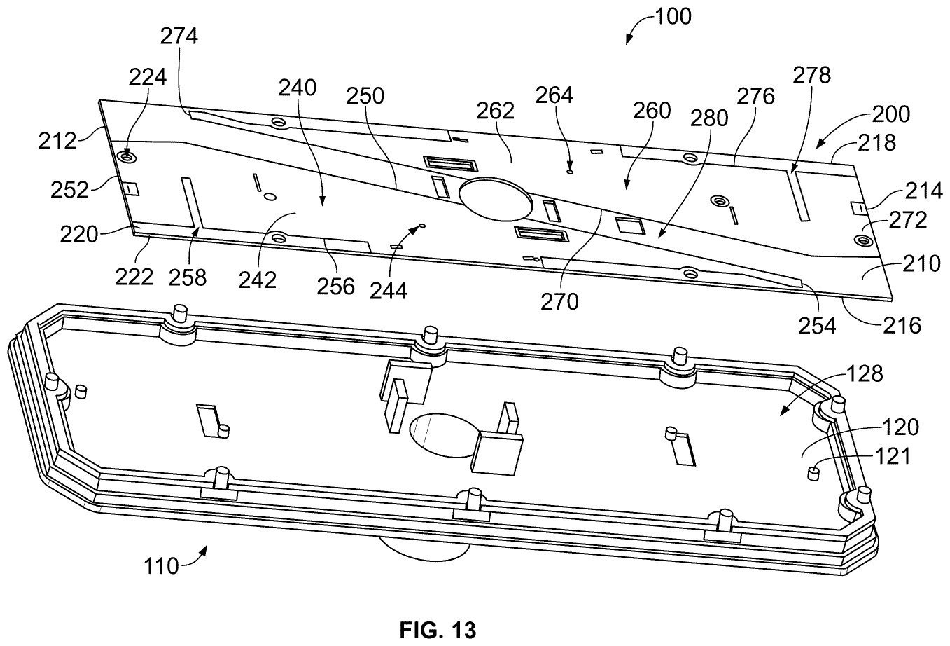

FIG. 13 is an exploded view of a portion of the vehicular antenna 100 in accordance with an exemplary embodiment. FIG. 13 shows a portion of the antenna assembly 200 poised for coupling to the base 120 of the housing 110. For example, FIG. 13 shows the substrate 210 of the antenna assembly 200 aligned with the antenna pocket 128 of the base 120. The substrate 210 may be lowered into the antenna pocket 128.

In an exemplary embodiment, the substrate 210 is a printed circuit board. The substrate 210 includes an upper surface 220 and a lower surface 222. The substrate 210 includes one or more openings 224 through the substrate 210. The openings 224 may receive portions of the base 120. In an exemplary embodiment, the base 120 includes posts 121 extending upward from the bottom wall. The posts 121 may be received in the corresponding openings 224 to locate the substrate 210 in the antenna pocket 128.

In an exemplary embodiment, the substrate 210 includes one or more ground elements configured to be electrically grounded to the feed cable 102 and the antenna elements. In the illustrated embodiment, the substrate 210 includes a pair of the ground elements. For example, the substrate 210 includes a first ground element 240 and a second ground element 260. The substrate 210 may include greater or fewer ground elements in alternative embodiments. In the illustrated embodiment, the first ground element 240 is provided at the first side 216 and the second ground element 260 is provided at the second side 218. The first ground element 240 may extend to the first and 212 and/or the second end 214. The second ground element 260 may extend to the first end 212 and/or the second end 214. In an exemplary embodiment, the first ground element 240 is isolated from the second ground element 260. For example, a ground gap 280 is provided between the first and second ground elements 240, 260.

The first ground element 240 is defined by one or more circuits, pads, traces, plated through holes, and the like of the printed circuit board. The first ground element 240 may be provided on one or more layers of the printed circuit board. For example, the first ground element 240 may be provided at the upper surface 220 and/or the lower surface 222. The first ground element 240 includes a panel 242 on the upper surface 220. In an exemplary embodiment, the first ground element 240 includes an identical ground panel or fully filled copper ground (with recess or via holes) on the lower surface 222. The lower panel may be electrically connected to the metal base 120. Alternatively, the lower panel may be isolated from the metal base 120. The lower ground panel may be shaped differently than the upper ground panel in various embodiments. In some embodiments, the substrate 210 includes a single lower ground panel under both ground elements 240, 260 that is electrically connected to both of the upper ground elements 240, 260 via the respective plated through holes.

In an exemplary embodiment, a plated through hole 244 extends through the printed circuit board to electrically connect the panels 242 at the upper and lower surfaces 220, 222. In an exemplary embodiment, the first ground element 240 includes a single plated through hole 244 to connect the panels 242 on the opposite sides of the printed circuit board. The single plated through hole 244 forces the current to flow along a dedicated path through the first ground element 240, which increases the overall effective length of the first ground element 240 to improve performance and efficiency of the antenna assembly 200 particularly for the low band frequencies. It also helps to reduce the impact of two different applications either on non metal surface and metal surface.

In an exemplary embodiment, the panel 242 of the first ground element 240 includes a tapered edge 250 extending between a connecting end 252 and a distal end 254. The connecting end 252 is configured to be connected to one of the antenna elements, such as the first cellular antenna 300. The panel 242 of the first ground element 240 includes an outer edge 256 opposite the tapered edge 250 that extends between the connecting end 252 and the distal end 254. In an exemplary embodiment, the tapered edge 250 is nonparallel to the outer edge 256. The outer edge 256 faces the first side 216 of the substrate 210. The tapered edge 250 faces the second ground element 260 across the ground gap 280. In an exemplary embodiment, the panel 242 of the first ground element 240 is triangular-shaped being wider at the connecting end 252 and narrower at the distal end 254. The panel 242 may have other shapes in alternative embodiments. The triangular shape of the panel 242 provides a maximum ground dimension for the first ground element 240 by locating the distal end 254 as far from the feed point for the first cellular antenna 300 as possible within the footprint confines of the housing 110 (for example, the connecting end 252 is located proximate to the first end 212 and the distal end 254 is located proximate to the second end 214).

In an exemplary embodiment, the plated through hole 244 is located at a central region of the panel 242, such as approximately centered between the connecting end 252 and the distal end 254 and/or approximately centered between the tapered edge 250 and the outer edge 256. The location of the plated through hole 244 may be selected to align with the cable routing of the feed cable 102 to minimize cable current effects. Other locations are possible in alternative embodiments.

In an exemplary embodiment, the panel 242 of the first ground element 240 may have one or more slots 258. The slots 258 may extend from the outer edge 256 and/or the tapered edge 250. The slots 258 may be provided for tuning. The slots 258 may be provided to control the flow of the current, such as to increase the overall length of the first ground element 240 even with the separate top layer ground plane condition.

The second ground element 260 is defined by one or more circuits, pads, traces, plated through holes, and the like of the printed circuit board. The second ground element 260 may be provided on one or more layers of the printed circuit board. For example, the second ground element 260 may be provided at the upper surface 220 and/or the lower surface 222. The second ground element 260 includes a panel 262 on the upper surface 220. In an exemplary embodiment, the second ground element 260 includes an identical panel or full copper filled (with recess and holes)on the lower surface 222. The lower panel may be electrically connected to the metal base 120. Alternatively, the lower panel may be isolated from the metal base 120. The lower ground panel may be shaped differently than the upper ground panel in various embodiments. In some embodiments, the substrate 210 includes a single lower ground panel under both ground elements 240, 260 that is electrically connected to both of the upper ground elements 240, 260 via the respective plated through holes.

In an exemplary embodiment, a plated through hole 264 extends through the printed circuit board to electrically connect the panels 262 at the upper and lower surfaces 220, 222. In an exemplary embodiment, the second ground element 260 includes a single plated through hole 264 to connect the panels 262 on the opposite sides of the printed circuit board. The single plated through hole 264 forces the current to flow along a dedicated path through the second ground element 260, which increases the overall effective electrical length of the second ground element 260 to improve performance and efficiency of the antenna assembly 200 particularly for the low band frequencies. It also helps to reduce the impact of two different applications either on non metal surface and metal surface.

In an exemplary embodiment, the panel 262 of the second ground element 260 includes a tapered edge 270 extending between a connecting end 272 and a distal end 274. The connecting end 272 is configured to be connected to one of the antenna elements, such as the second cellular antenna 400. The panel 262 of the second ground element 260 includes an outer edge 276 opposite the tapered edge 270 that extends between the connecting end 272 and the distal end 274. In an exemplary embodiment, the tapered edge 270 is nonparallel to the outer edge 276. The outer edge 276 faces the second side 218 of the substrate 210. The tapered edge 270 faces the first ground element 240 across the ground gap 280. In an exemplary embodiment, the panel 262 of the second ground element 260 is triangular-shaped being wider at the connecting end 272 and narrower at the distal end 274. The panel 262 may have other shapes in alternative embodiments. The triangular shape of the panel 262 provides a maximum ground dimension for the second ground element 260 by locating the distal end 274 as far from the feed point for the second cellular antenna 400 as possible within the footprint confines of the housing 110 (for example, the connecting end 272 is located proximate to the second end 214 and the distal end 274 is located proximate to the first end 212).

In an exemplary embodiment, the plated through hole 264 is located at a central region of the panel 262, such as approximately centered between the connecting end 272 and the distal end 274 and/or approximately centered between the tapered edge 270 and the outer edge 276. The location of the plated through hole 264 may be selected to align with the cable routing to minimize cable current effects. Other locations are possible in alternative embodiments.

In an exemplary embodiment, the panel 262 of the second ground element 260 may have one or more slots 278. The slots 278 may extend from the outer edge 276 and/or the tapered edge 270. The slots 278 may be provided for tuning. The slots 278 may be provided to control the flow of the current, such as to increase the overall length of the second ground element 260 even with the separate top layer ground plane condition.

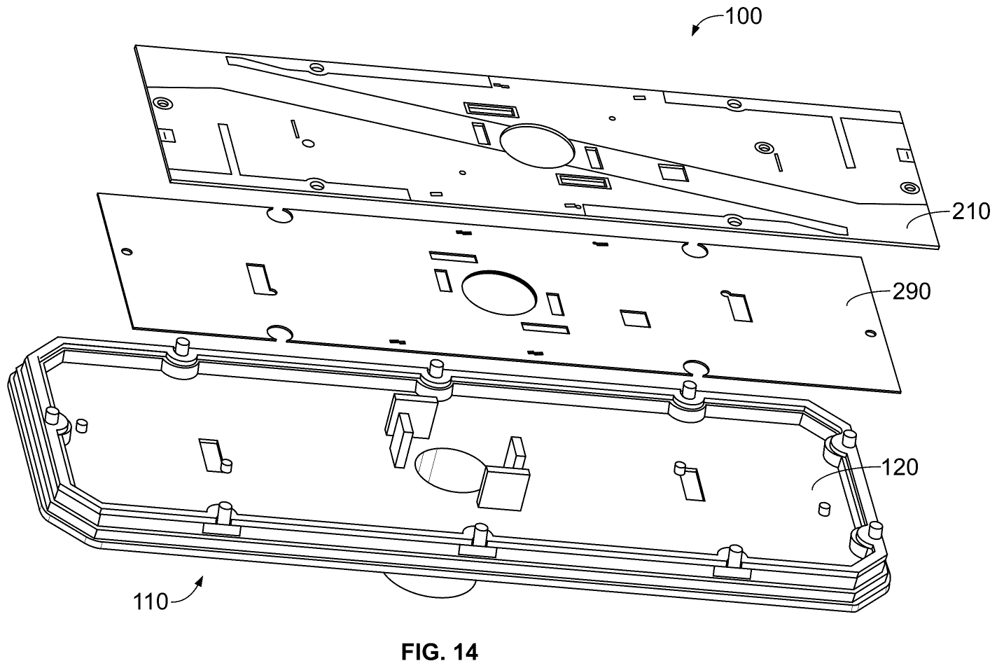

FIG. 14 is an exploded view of a portion of the vehicular antenna 100 in accordance with an exemplary embodiment. The embodiment shown in FIG. 14 is similar to the embodiment shown in FIG. 13 but includes an isolation layer 290 between the substrate 210 and the base 120 of the housing 110. The isolation layer 290 may be a solder mask. The isolation layer 290 may be a dielectric film. The isolation layer 290 separates the first and second ground elements 240, 260 from the metal base 220.

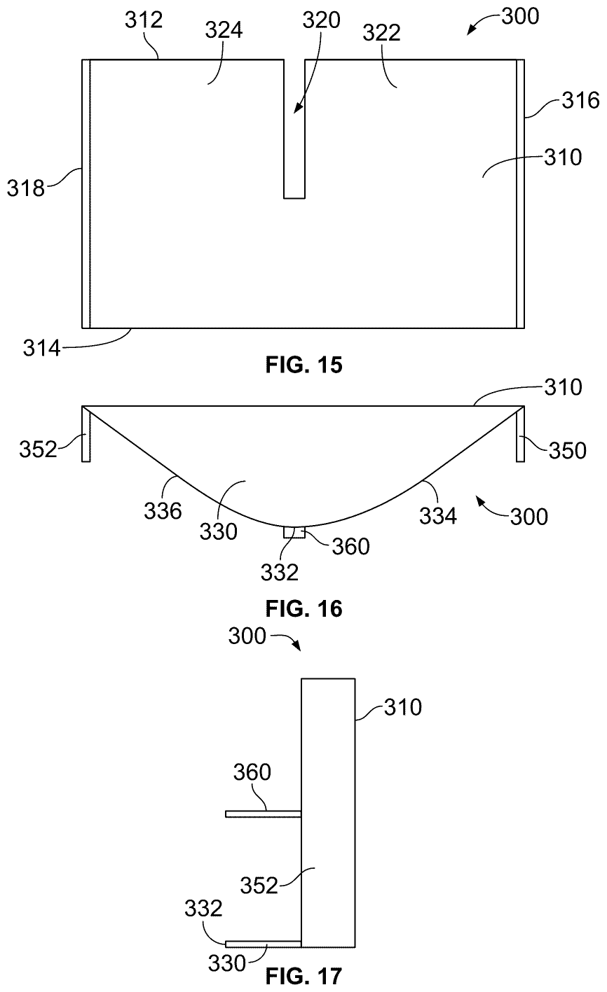

FIG. 15 is a top view of the first cellular antenna 300 in accordance with an exemplary embodiment. FIG. 16 is an end view of the first cellular antenna 300 in accordance with an exemplary embodiment. FIG. 17 is a side view of the first cellular antenna 300 in accordance with an exemplary embodiment. In an exemplary embodiment, the second cellular antenna 400 (shown in FIG. 19) may be similar or identical to the first cellular antenna 300 and like elements/components may be identified hereinafter using like reference numerals.

In an exemplary embodiment, the cellular antenna 300 is a stamped and formed antenna element stamped from a metal sheet and formed into a particular shape. For example, the cellular antenna 300 may include multiple panels or segments that are connected at bend or fold lines. In alternative embodiments, the cellular antenna 300 may be formed by one or more traces on a printed circuit board or a flexible circuit.

The cellular antenna 300 includes a patch panel 310 and a feed panel 330 extending from the patch panel 310. In an exemplary embodiment, the patch panel 310 is oriented horizontally and the feed panel 330 is oriented vertically. For example, the feed panel 330 is configured to extend between the patch panel 310 and a feed point 332 configured to be connected to the feed cable 102 and/or the ground element 240.

The patch panel 310 extends between a front 312 and a rear 314. The patch panel 310 includes a first side 316 and a second side 318 opposite the first side 316. The sides 316, 318 extend between the front 312 and the rear 314. The feed panel 330 extends from the rear 314. In various embodiments, the sides 316, 318 extend parallel to each other. In alternative embodiments, the sides 316, 318 extends nonparallel to each other.

In an exemplary embodiment, the patch panel 310 includes one or more slots 320. The slot 320 may be approximately centered between the sides 316, 318. Alternatively, the slot 320 may be offset closer to the first side 316 or the second side 318. The slot 320 is open at the front 312. The slot 320 may be open at the rear 314 or one of the sides 316, 318 in alternative embodiments. In the illustrated embodiment, the slot 320 is rectangular. The slot 320 may have other shapes in alternative embodiments. The patch panel 310 includes a first patch section 322 at the first side of the slot 320 (for example, between the slot 320 in the first side 312) and a second patch section 324 at the second side of the slot 320 (for example, between the slot 320 and the second side 314). The first and second patch sections 322, 324 may be symmetrical (for example, have the same width and length). Alternatively, the first and second patch sections 322, 324 may be asymmetrical (for example, have a different width and/or a different length and/or a different shape).

The feed panel 330 extends from the patch panel 310. In an exemplary embodiment, the feed panel 330 is oriented generally perpendicular to the patch panel 310. However, the feed panel 330 may be oriented at other angles in alternative embodiments. In an exemplary embodiment, the feed panel 330 is a tapered feed panel being tapered inward from the patch panel 310 to the feed point 332. For example, the tapered feed panel 330 includes a first tapered edge 334 between the first side 316 and the feed point 332 and a second tapered edge 336 between the second side 318 and the feed point 332. The tapered edges 334, 336 may be linear. Alternatively, the tapered edges 334, 336 may be curved. In other alternative embodiments, the tapered edges 334, 336 may include multiple sections or segments that are angled or curved relative to each other. In an exemplary embodiment, the feed panel 330 is symmetrical having the feed point 332 centered between the first and second sides of the feed panel 330 and having the tapered edges 334, 336 symmetrical relative to each other. In alternative embodiments, the feed panel 330 may be asymmetrical, such as having the feed point 332 offset toward one side or the other and/or having the tapered edges 334, 336 having different shapes.

In an exemplary embodiment, the cellular antenna 300 includes extended side walls 350, 352 at the first and second sides 316, 318. The side walls 350, 352 extend downward from the patch panel 310. The side walls 350, 352 may be rectangular. However, the side walls 350, 352 may have other shapes in alternative embodiments. In various embodiments, the side walls 350, 352 are shorter than the feed panel 330 such that the feed panel 330 extends below the bottom edges of the side walls 350, 352. Alternatively, the side walls 350, 352 may have similar height to the feed panel 330 such that the side walls 350, 352 interface with the ground structure. The side walls 350, 352 may extend the entire length between the front 312 and the rear 314. Alternatively, the side walls 350, 352 may be shorter than the patch panel 310 extending from the front 312 or the rear 314.

In an exemplary embodiment, the cellular antenna 300 includes a shorting pin 360 extending from the patch panel 310. The shorting pin 360 may be stamped and formed from the patch panel 310. For example, the shorting pin 360 may be stamped to form the slot 320. The shorting pin 360 extends downward from the patch panel 310 and is configured to connect to the ground structure, such as the ground element 240. The shorting pin 360 electrically connects the patch panel 310 to the ground element 240. In an exemplary embodiment, the shorting pin 360 is used to mechanically support the patch panel 310. For example, the shorting pin 360 may hold the patch panel 310 at an elevated position above the ground element 240.

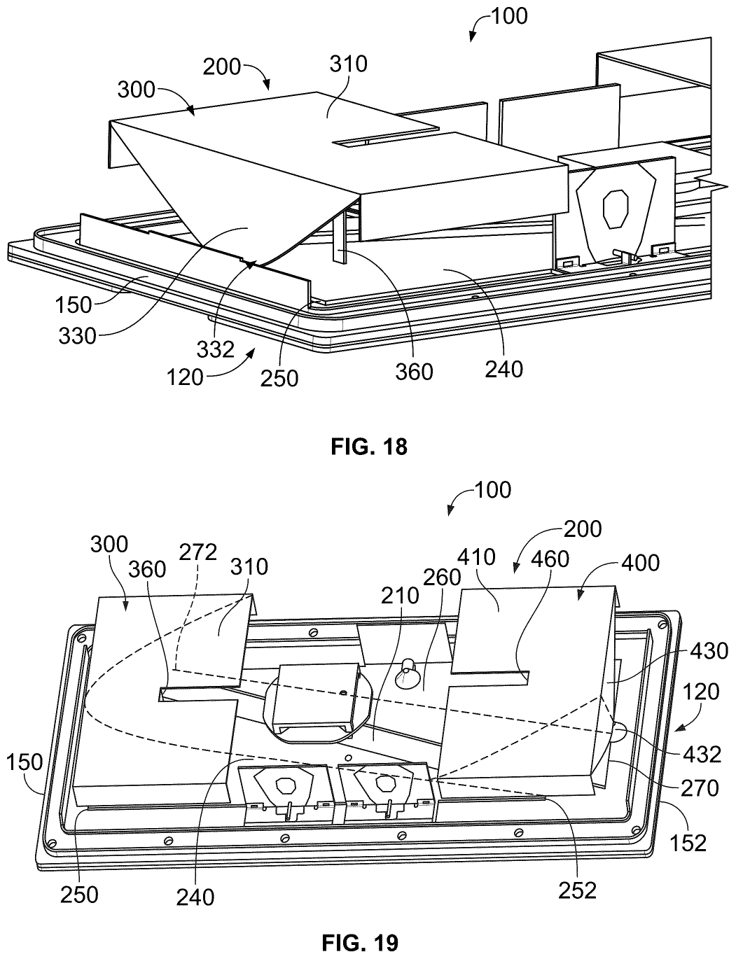

FIG. 18 is a perspective view of a portion of the vehicular antenna 100 showing the antenna assembly 200 coupled to the base 120. FIG. 19 is a top perspective view of a portion of the vehicular antenna 100 showing the antenna assembly 200 coupled to the base 120. FIG. 18 shows the first cellular antenna 300. FIG. 19 shows both the first and second cellular antennas 300, 400. The second cellular antenna 400 is inverted or rotated 180° relative to the first cellular antenna 300 such that the first and second cellular antennas 300, 400 are provided at the opposite ends 150, 152 of the base 120.

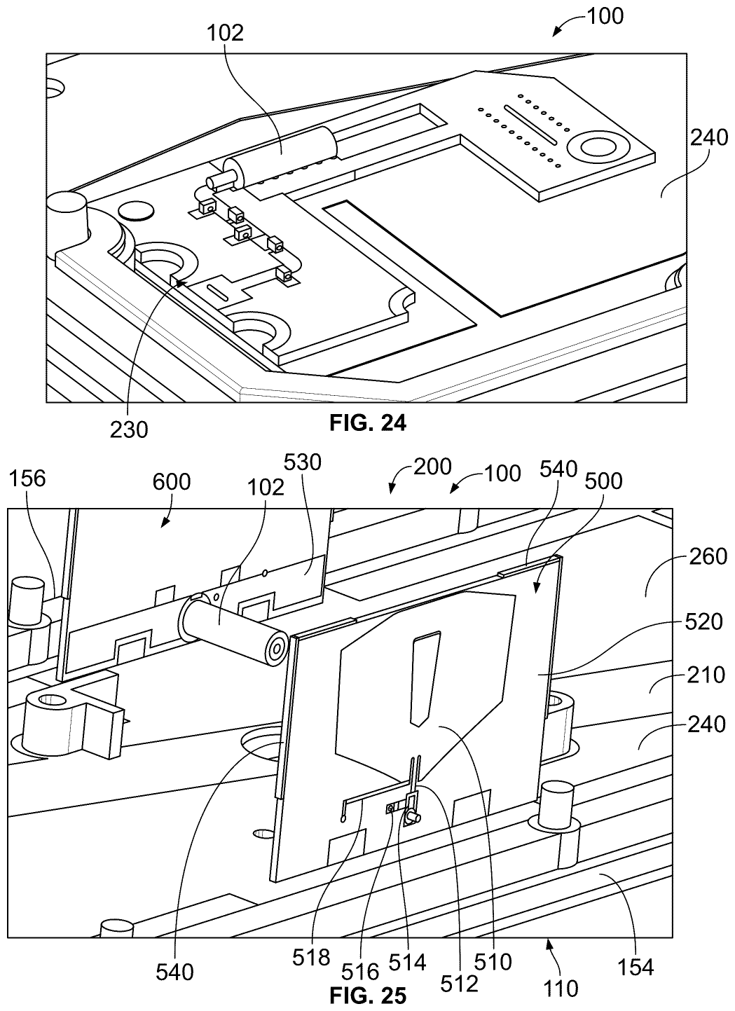

In an exemplary embodiment, the first cellular antenna 300 is provided at the first end 150 of the base 120. The first cellular antenna 300 is configured to be mounted to the substrate 210. For example, the first cellular antenna 300 is configured to be coupled to the first ground element 240. The feed panel 330 is coupled to the first ground element 240 at the feed point 332. For example, the feed panel 330 may be soldered to the center core of a coaxial cable which its braid grounded to the first ground element 240. In various embodiments, the interface between the feed panel 330 and coaxial cable 102 is achieved via a feeding board 230 (FIG. 24) which is grounded to the ground element 240. The feeding board has a pair of grounding pads (with plated through hole and slot) which allow the coaxial cable to seat between them for coaxial braid soldering. The center core of the coaxial cable 102 may be soldered to a microstrip line. The microstrip line provides a soldering pad for lump components (matching network) which is used for further improvement to the antenna matching (VSWR) that subsequently improve the antenna efficiency. The other end of the microstrip line is a soldering pad with plated through hole for the feeding panel 330 soldering at 332 or with other means of contact e.g. spring contact clip. The feeding board 230 can be attached to ground element 240 by soldering to the ground plane. The shorting pin 360 may be coupled to the first ground element 240. For example, the shorting pin 360 may be soldered to the first ground element 240. In various embodiments, the feeding board 230 can be made with extended size that preparing a soldering pad (with PTH to the other side of ground layer) for the shorting pin 360.

In an exemplary embodiment, the second cellular antenna 400 is provided at the second end 152 of the base 120. The second cellular antenna 400 is configured to be mounted to the substrate 210. For example, the second cellular antenna 400 is configured to be coupled to the second ground element 260. A feed panel 430 is coupled to the second ground element 260 at a feed point 432. For example, the feed panel 430 may be soldered to the center core of a coaxial cable which its braid grounded to the first ground element 260. In various embodiments, the interface between the feed panel 430 and the coaxial cable 102 is achieved via a feeding board 230 which is grounded to the ground element 260. The feeding board has a pair of grounding pad (with plated through hole and slot) which allow the coaxial cable seats between them for coaxial braid soldering. The center core of the coaxial cable 102 is soldered to microstrip line. The microstrip line provide soldering pad for lump components (matching network) which is used for further improvement to the antenna matching (VSWR) that subsequently improve the antenna efficiency. The other end of the microstrip line is a soldering pad with plated through hole for the feeding panel 330 soldering at 332 or with other means of contact e.g. spring contact clip. The feeding board 230 can be attached to ground element 240 by soldering to the ground plane. to the second ground element 260. A shorting pin 460 extending from a patch panel 410 may be coupled to the second ground element 260. For example, the shorting pin 460 may be soldered to the second ground element 260. In various embodiments, the feeding board 230 can be with extended size that preparing a soldering pad (with PTH to the other side of ground layer) for the shorting pin 360.

In an exemplary embodiment, the first and second ground elements 240, 260 traverse across the substrate 210 between the first and second ends 150, 152 of the housing 110. For example, the connecting end 250 of the first ground element 240 is located proximate to the first end 150 and the distal end 252 of the first ground element 240 is located proximate to the second end 152. Similarly, the connecting end 270 of the second ground element 260 is located proximate to the second end 152 and distal end 272 of the second ground element 260 is located proximate to the first end 150. The first connecting end 250 is located below the first patch panel 310. The first distal end 252 is located below the second patch panel 410. The second connecting end 270 is located below the second patch panel 410. The second distal end 272 is located below the first patch panel 310. As such, the first and second ground elements 240, 260 have long electrical lengths that span generally the entire length of the housing 110 to improve performance of the first and second cellular antennas 300, 400. For example, the effective lengths of the first and second cellular antennas 300, 400 are shown by the arrows extending from the outer edges of the patch panels 310, 410, through the feed panels 330, 430, and along the first and second ground elements 240, 260 to the distal ends 252, 272. The long effective lengths of the antennas improves performance, particularly in the low frequency bands.

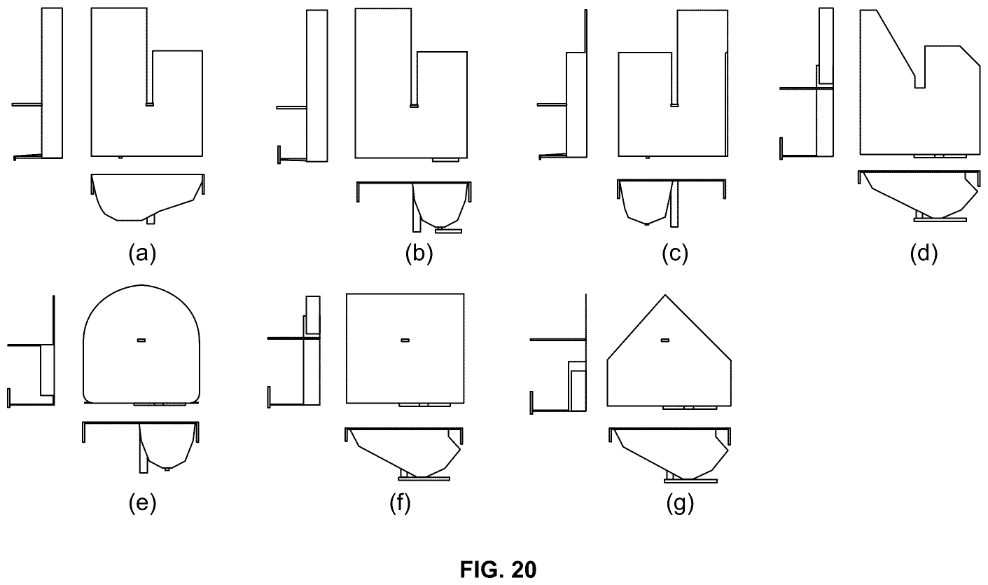

FIG. 20(a)-(g) illustrate alternative shapes for the cellular antenna elements. For example, the patch panels and/or the feed panels may be asymmetrical, such as having different size or shape segments. The extended side walls may be asymmetrical. The slots may be asymmetrical. The shapes of the cellular antennas may be designed for efficient operation at particular frequency ranges.

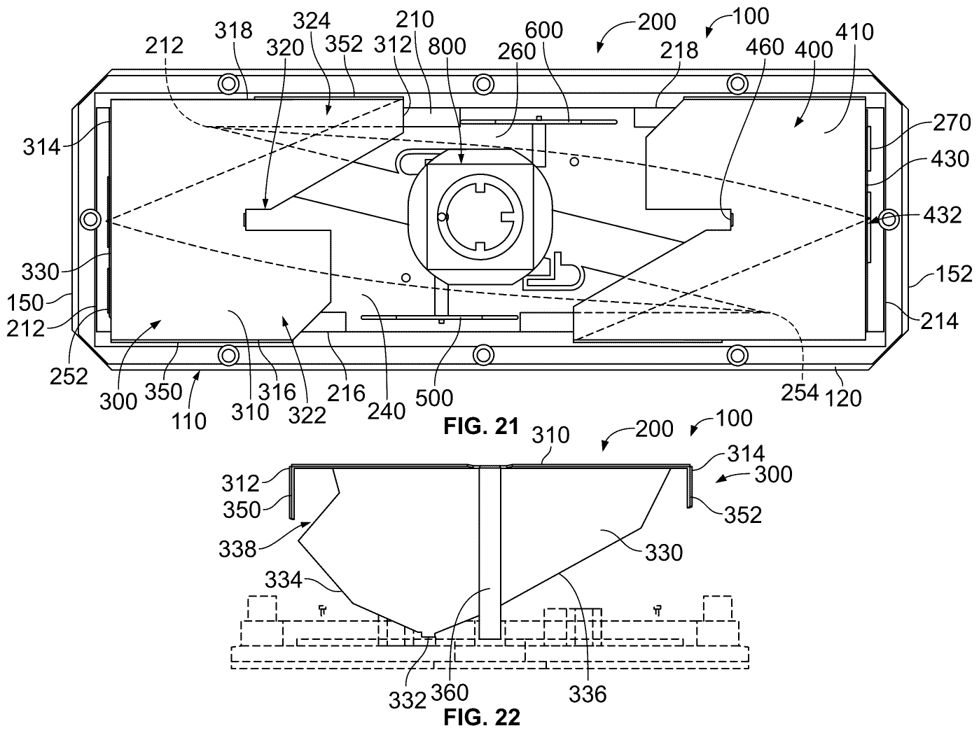

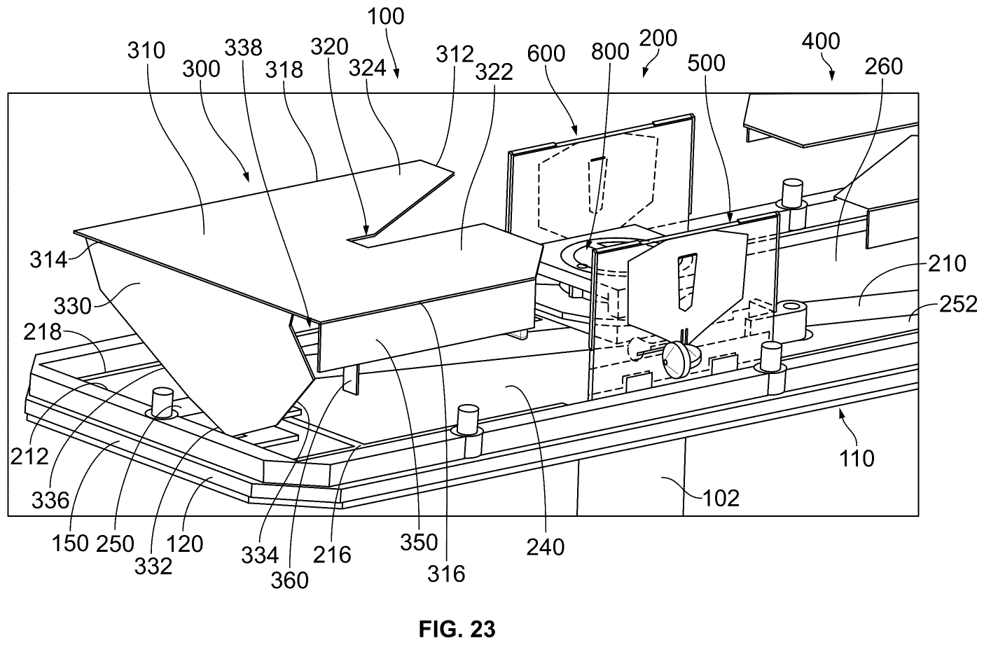

FIG. 21 is a top view of a portion of the vehicular antenna 100 in accordance with an exemplary embodiment. FIG. 22 is a front view of a portion of the vehicular antenna 100 in accordance with an exemplary embodiment. FIG. 23 is a perspective view of a portion of the vehicular antenna 100 in accordance with an exemplary embodiment. FIGS. 21-23 illustrate the cellular antennas 300, 400 having an alternative shape (for example, corresponding to FIG. 20(d)) compared to the cellular antenna element shown in FIGS. 15-17. In an exemplary embodiment, the second cellular antenna 400 (FIG. 21) may be similar or identical to the first cellular antenna 300 and like elements/components may be identified hereinafter using like reference numerals. The second cellular antenna 400 is inverted or rotated 180° relative to the first cellular antenna 300 such that the first and second cellular antennas 300, 400 are provided at the opposite ends 150, 152 of the base 120.

In an exemplary embodiment, the antenna assembly 200 includes the first cellular antenna 300, the second cellular antenna 400, the first Wi-Fi antenna 500, the second Wi-Fi antenna 600, which may be a combined antenna element combined with a Bluetooth antenna, and the GNSS antenna 800. In the illustrated embodiment, the first cellular antenna 300 is provided at the first and 212 and the second cellular antenna 400 is provided at the second end 214. The first and second cellular antennas 300, 400 are located at the opposite ends 212, 214 to provide isolation between the cellular antennas 300, 400. In the illustrated embodiment, the first Wi-Fi antenna 500 is provided at the first side 216 and the second Wi-Fi antenna 600 is provided at the second side 218. The first and second Wi-Fi antennas 500, 600 are located between the first and second cellular antennas 300, 400.

In an exemplary embodiment, the cellular antenna 300 is a stamped and formed antenna element stamped from a metal sheet and formed into a particular shape. For example, the cellular antenna 300 may include multiple panels or segments that are connected at bend or fold lines. The cellular antenna 300 includes the patch panel 310 and the feed panel 330 extending from the patch panel 310. The feed panel 330 is configured to extend between the patch panel 310 and the feed point 332 configured to be connected to the feed cable 102 and/or the ground element 240.

The patch panel 310 extends between the front 312 and the rear 314. The patch panel 310 includes the first side 316 and the second side 318 opposite the first side 316. In an exemplary embodiment, the cellular antenna 300 includes the extended side walls 350, 352 at the first and second sides 316, 318. In an exemplary embodiment, the cellular antenna 300 includes the shorting pin 360 extending from the patch panel 310 to the ground element 240. In an exemplary embodiment, the patch panel 310 includes the slot 320. In the illustrated embodiment, the slot 320 is asymmetrical, such as being tapered outward toward the first side. The patch panel 310 includes the first patch section 322 at the first side of the slot 320 (for example, between the slot 320 in the first side 312) and the second patch section 324 at the second side of the slot 320 (for example, between the slot 320 and the second side 314). In the illustrated embodiment, the first and second patch sections 322, 324 are asymmetrical. For example, the second patch section 324 is longer than the first patch section 322. The first patch section 322 is wider than the second patch section 324. The second patch section 324 includes a chamfered edge, such as at the slot 320. The first patch section 322 includes a chamfered edge, such as at the first side 316. The chamfered sections may be provided to provide spacing to other antenna elements, such as to improve isolation.

The feed panel 330 extends from the patch panel 310. In an exemplary embodiment, the feed panel 330 is a tapered feed panel being tapered inward from the patch panel 310 to the feed point 332. For example, the tapered feed panel 330 includes the first tapered edge 334 between the first side 316 and the feed point 332 and the second tapered edge 336 between the second side 318 and the feed point 332. The tapered edges 334, 336 are asymmetrical in the illustrated embodiment. For example, the feed point 332 is offset toward one side. The tapered edges 334, 336 having different shapes. In an exemplary embodiment, the first tapered edge 334 has a cutback 338, which increases the overall length of the tapered edge 334, such as to improve performance by increasing the overall length of the electrical path which improves efficiency, particularly at the low band frequencies.

In an exemplary embodiment, the first cellular antenna 300 is provided at the first end 150 of the base 120. The first cellular antenna 300 is configured to be mounted to the substrate 210. For example, the first cellular antenna 300 is configured to be coupled to the first ground element 240. The feed panel 330 is coupled to the first ground element 240 at the feed point 332. The shorting pin 360 may be coupled to the first ground element 240.

In an exemplary embodiment, the second cellular antenna 400 is provided at the second end 152 of the base 120. The second cellular antenna 400 is configured to be mounted to the substrate 210. For example, the second cellular antenna 400 is configured to be coupled to the second ground element 260. The feed panel 430 is coupled to the second ground element 260 at the feed point 432. The shorting pin 460 extending from the patch panel 410 may be coupled to the second ground element 260.

In an exemplary embodiment, the first and second ground elements 240, 260 traverse across the substrate 210 between the first and second ends 150, 152 of the housing 110. For example, the connecting end 250 of the first ground element 240 is located proximate to the first end 150 and the distal end 252 of the first ground element 240 is located proximate to the second end 152. Similarly, the connecting end 270 of the second ground element 260 is located proximate to the second end 152 and distal end 272 of the second ground element 260 is located proximate to the first end 150. The first connecting end 250 is located below the first patch panel 310. The first distal end 252 is located below the second patch panel 410. The second connecting end 270 is located below the second patch panel 410. The second distal end 272 is located below the first patch panel 310. As such, the first and second ground elements 240, 260 have long electrical lengths that span generally the entire length of the housing 110 to improve performance of the first and second cellular antennas 300, 400. For example, the effective lengths of the first and second cellular antennas 300, 400 are shown by the arrows extending from the outer edges of the patch panels 310, 410, through the feed panels 330, 430, and along the first and second ground elements 240, 260 to the distal ends 252, 272. The long effective lengths of the antennas improve performance, particularly in the low frequency bands.

FIG. 24 illustrates a portion of the vehicular antenna 100 in accordance with an exemplary embodiment. FIG. 24 shows a matching circuit 230 for the antenna feed. The feed cable 102 is configured to be coupled to the matching circuit 230, such as being soldered to a circuit trace 232 of the matching circuit 230. The ground shield is configured to be coupled to the matching circuit 230.

FIG. 25 illustrates a portion of the vehicular antenna 100 in accordance with an exemplary embodiment. FIG. 25 shows the first and second Wi-Fi antennas 500, 600. In an exemplary embodiment, the first and second Wi-Fi antennas 500, 600 may be similar or identical to each other and like elements/components may be identified hereinafter using like reference numerals.

The Wi-Fi antenna 500 includes one or more radiating elements 510 operable in the corresponding frequency band. The radiating element 510 is configured to be connected to the feed cable 102. The Wi-Fi antenna 500 includes a feed line 512 between the radiating element 510 and the feed cable 102. In an exemplary embodiment, the Wi-Fi antenna 500 includes a series capacitor 514 coupled to the radiating element 510 and/or the feed line 512 for high band impedance. In an exemplary embodiment, the Wi-Fi antenna 500 includes a shunt resistor 516, such as for antenna detection from an RF module. In an exemplary embodiment, the Wi-Fi antenna 500 includes a shorting trace 518 between the radiating element 510 and/or the feed line 512 and a ground structure.

In an exemplary embodiment, the Wi-Fi antenna 500 includes a circuit board 520. The radiating element 510 is provided on the circuit board 520, such as being one or more circuits, pads, traces, vias, or other conductors of the circuit board 520. In the illustrated embodiment, the circuit board 520 is oriented vertically, such as being located and extending above the substrate 210. In various embodiments, the circuit board 520 may extend lengthwise within the housing 110, such as being parallel to the sides 154, 156. The circuit board 520 holds the radiating element 510 along a surface of the circuit board 520. For example, the radiating element 510 extends vertically and parallel to the sides 154, 156. In an exemplary embodiment, the radiating element 510 is located at the outer surface of the circuit board 520 facing outward away from the center of the antenna assembly 200. In alternative embodiments, the radiating element 510 is a stamped and formed antenna element stamped from a metal sheet and formed into a particular shape, and may be provided without the circuit board 520.

In an exemplary embodiment, the Wi-Fi antenna 500 includes a ground element 530. The ground element 530 is coupled to the cable shield of the feed cable 102. The ground element 530 may be electrically connected to the shorting trace 518, such as by a vias through the circuit board 520. The ground element 530 may be provided on one or more layers of the circuit board 520. In the illustrated embodiment, the ground element 530 is provided at the inner surface of the circuit board 520 facing the center of the antenna assembly 200 the ground element 530 may be provided on the opposite side of the circuit board 520 from the radiating element 510. In an exemplary embodiment, the ground element 530 is a suspended ground element electrically isolated from the ground element 240 of the substrate 210. The ground element 530 is isolated from the ground element 240 to improve isolation between the antenna elements of the antenna assembly 200.

In an exemplary embodiment, the Wi-Fi antenna 500 includes one or more parasitic radiating elements 540. The parasitic radiating elements 540 may improve one or more antenna characteristics of the Wi-Fi antenna 500. For example, the parasitic radiating elements 540 may improve horizontal gain of the Wi-Fi antenna 500. In the illustrated embodiment, the parasitic radiating elements 540 are provided at the upper corners of the PCB 520. Other locations are possible in alternative embodiments. The parasitic radiating elements 540 may be formed by an edge plating edges of the PCB 520. In other various embodiments, the parasitic radiating elements 540 may be formed by one or more traces or conductors of the PCB 520. In alternative embodiments, the parasitic radiating elements 540 may be stamped and formed metal pieces attached to the PCB 520, such as at the corners and/or along the edges.

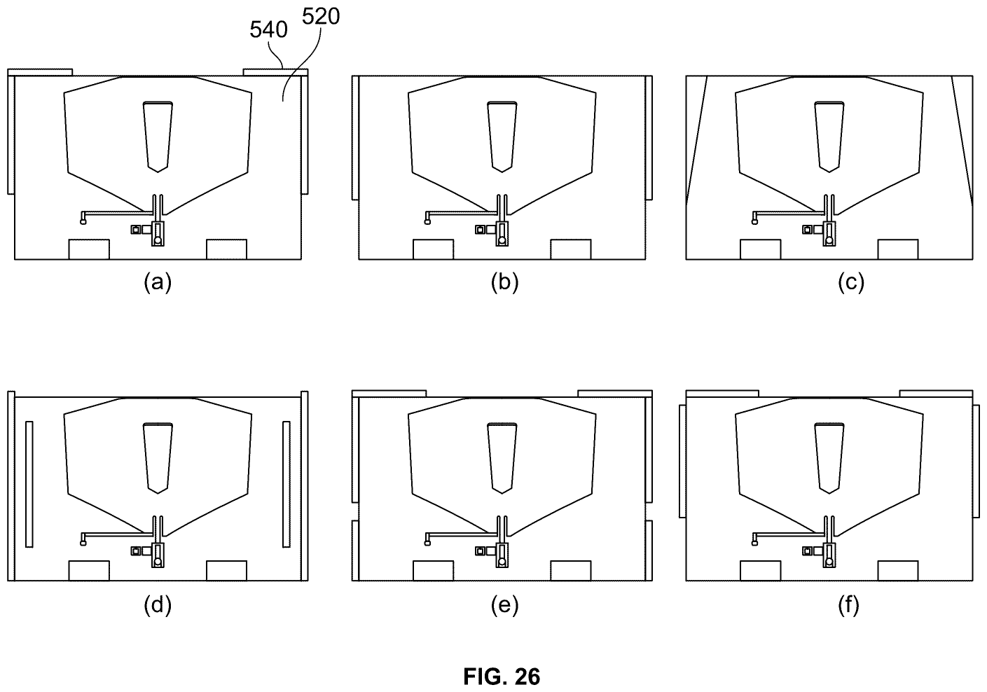

FIG. 26(a)-(f) illustrate alternative arrangements of the parasitic radiating elements 540 in accordance with alternative embodiments. For example, the parasitic radiating elements 540 may be provided along one or more of the edges of the PCB 520 and/or along one or more of the services of the PCB 520. In various embodiments, the parasitic radiating elements 540 may be directly connected to each other. In other embodiments, the parasitic radiating elements 540 may be separate or discrete components that are separated from each other by gaps or spaces. The shapes and locations of the parasitic radiating elements 540 may be designed for efficient operation at particular frequency ranges.

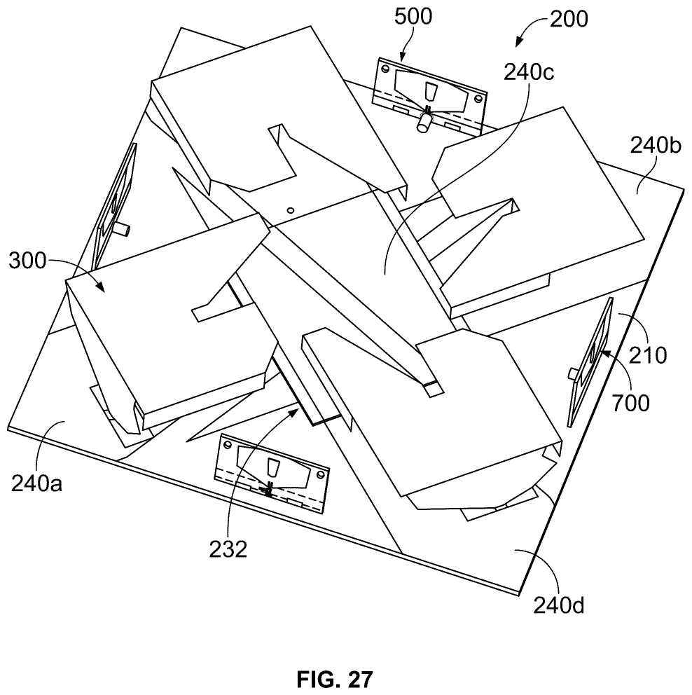

FIG. 27 illustrates the antenna assembly 200 in accordance with an exemplary embodiment. In the illustrated embodiment, the antenna assembly 200 is a 4×4 MIMO antenna assembly including four of the cellular antenna elements 300 arranged at different quadrants. For example, the four cellular antenna elements 300 may be arranged in four corners of the substrate 210 of the antenna assembly 200. In an exemplary embodiment, the antenna assembly 200 includes four of the Wi-Fi antennas 500 and/or Bluetooth antennas 700 arranged in the spaces between the cellular antenna elements 300. In an exemplary embodiment, the antenna assembly 200 includes four of the ground elements 240 arranged on the substrate 210. Each ground element 240 is associated with one of the cellular antenna elements 300. The ground elements 240 are electrically isolated from each other or they can be isolated at the top layer but shorted to ground via the PTH depending on the needs of DC isolation from the metal base.

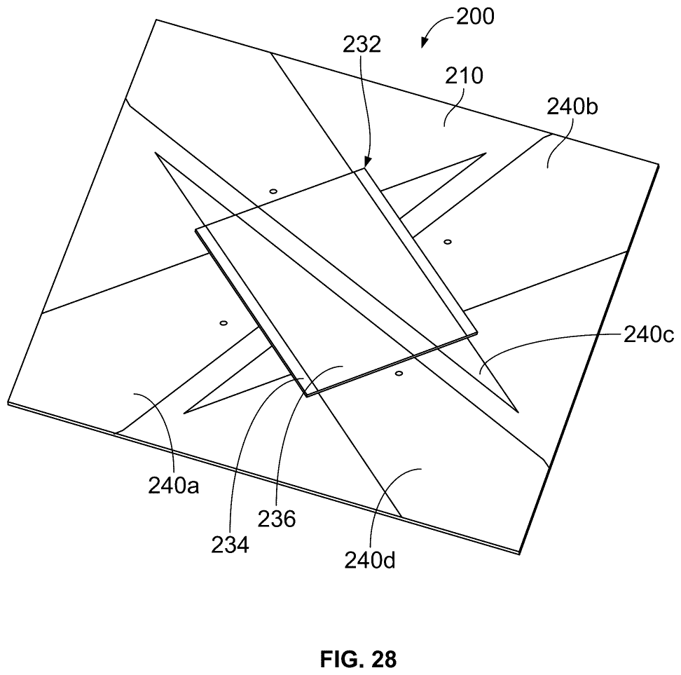

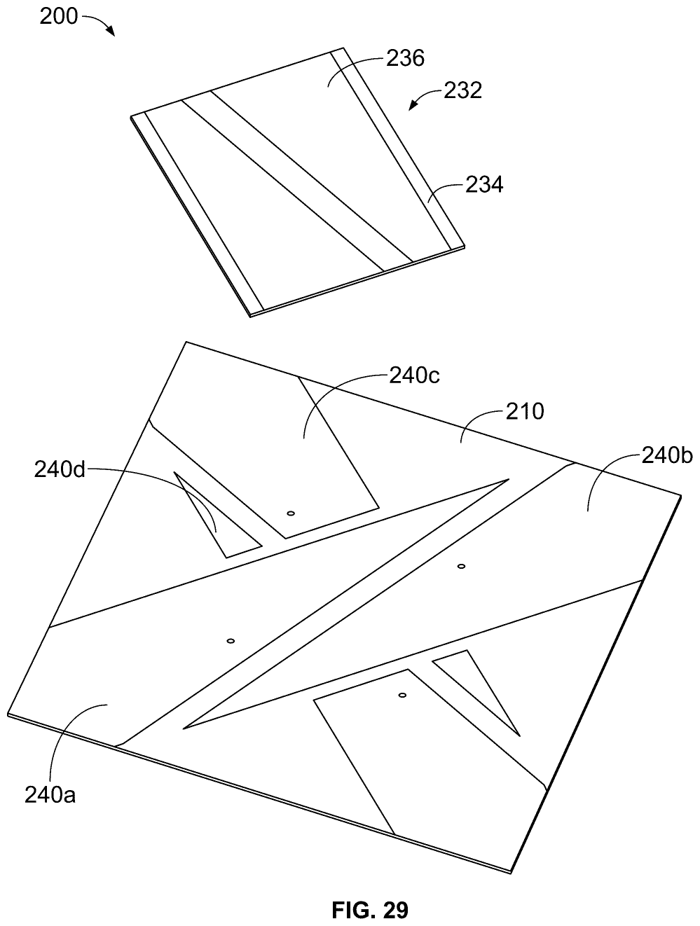

With additional reference to FIG. 28, which is a top perspective view of a portion of the antenna assembly 200 shown in FIG. 27, and FIG. 29, which is an exploded view of a portion of the antenna assembly 200 shown in FIG. 27, in an exemplary embodiment, the antenna assembly 200 includes a ground bridge 232 used to isolate the various ground elements 240. For example, the ground bridge 232 allows two of the ground elements 240 to span over and across the other two ground elements 240. For example, first and second ground elements 240a, 240b may be provided directly on the upper surface of the substrate 210 whereas third and fourth ground elements 240c, 240d are provided on the ground bridge 232 to span over the first and second ground elements 240a, 240b. The ground bridge 232 may be a printed circuit board having a substrate 234 and conductors 236 on one or more layers of the substrate 234. In an exemplary embodiment, some segments of the third and fourth ground elements 240c, 240d are defined by conductors (for example, circuits, pads, traces, and the like) on the upper surface of the substrate 210 and other segments of the third and fourth ground elements 240c, 240d are defined by the conductors 236 of the ground bridge 232. The dielectric substrate 234 of the ground bridge 232 electrically isolates the segments of the third and fourth ground elements 240c, 240d from the first and second ground elements 240a, 240b on the substrate 210. In various embodiments, the ground elements can be isolated at the top layer but shorted to bottom layer ground via the PTH depending on the needs of DC isolation from the metal base.

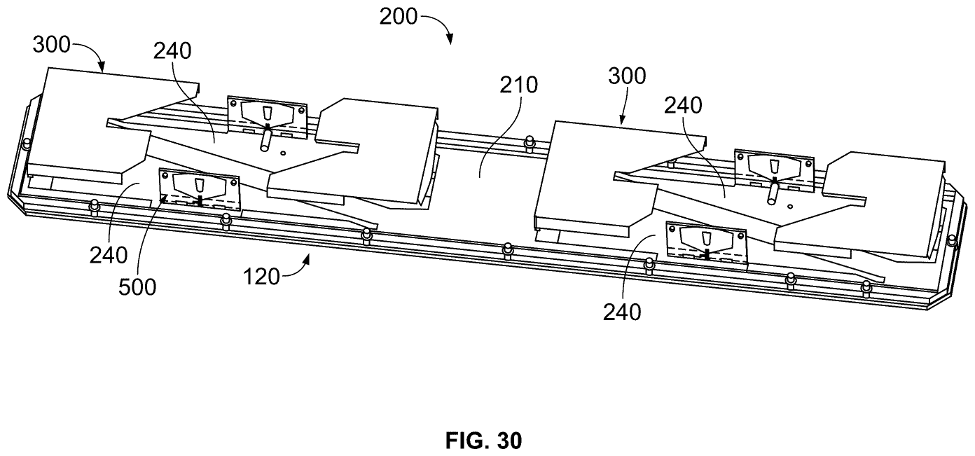

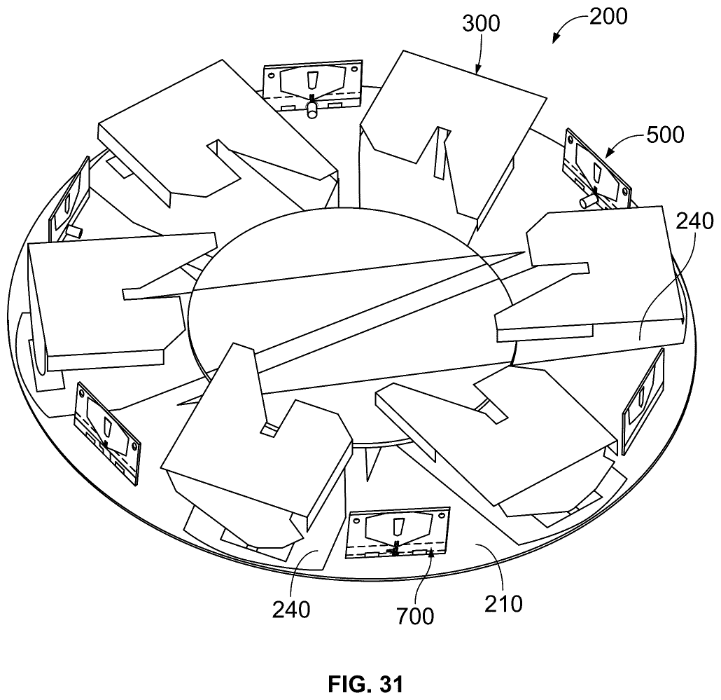

FIG. 30 illustrates the antenna assembly 200 in accordance with an exemplary embodiment. In the illustrated embodiment, the antenna assembly 200 is a 4×4 MIMO antenna assembly including four of the cellular antenna elements 300. For example, the four cellular antenna elements 300 are arranged in two groups or pairs of the cellular antenna elements 300. The groups of the cellular antenna elements 300 are arranged and two and along the elongated base 120. In an exemplary embodiment, the antenna assembly 200 includes four of the Wi-Fi antennas 500 and/or Bluetooth antennas 700 arranged in spaces between the pairs of the cellular antenna elements 300. In an exemplary embodiment, the antenna assembly 200 includes four of the ground elements 240 arranged on the substrate 210. Each ground element 240 is associated with one of the cellular antenna elements 300. The ground elements 240 are electrically isolated from each other. In various embodiments, the ground elements can be isolated at the top layer but shorted to bottom layer ground via the PTH depending on the needs of DC isolation from the metal base.

FIG. 31 illustrates the antenna assembly 200 in accordance with an exemplary embodiment. In the illustrated embodiment, the antenna assembly 200 is a 6×6 MIMO antenna assembly including six of the cellular antenna elements 300 arranged circumferentially around the circular substrate 210. The cellular antenna elements 300 may be arranged in pairs across from each other on opposite sides of the substrate 210. In an exemplary embodiment, the antenna assembly 200 includes six of the Wi-Fi antennas 500 and/or Bluetooth antennas 700 arranged in the spaces between the cellular antenna elements 300. In an exemplary embodiment, the antenna assembly 200 includes six of the ground elements 240. Each ground element 240 is associated with one of the cellular antenna elements 300. The ground elements 240 are electrically isolated from each other. In various embodiments, the ground elements can be isolated at the top layer but shorted to bottom layer ground via the PTH depending on the needs of DC isolation from the metal base.

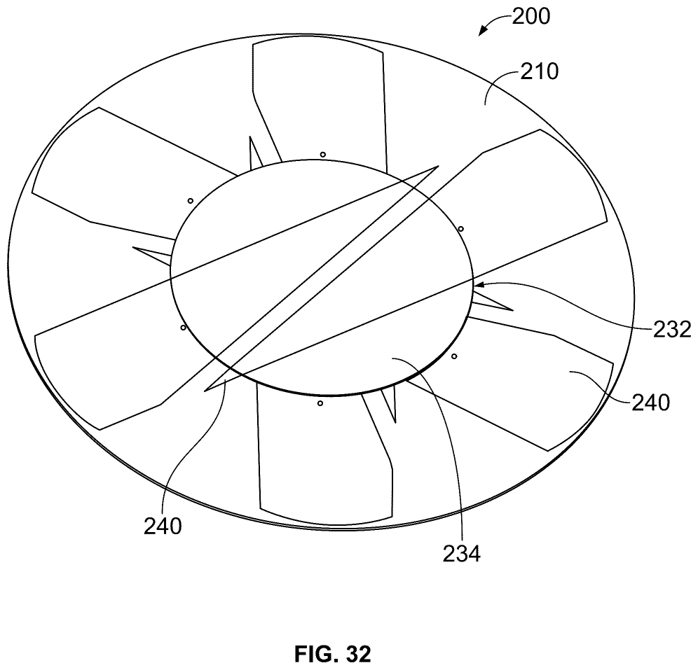

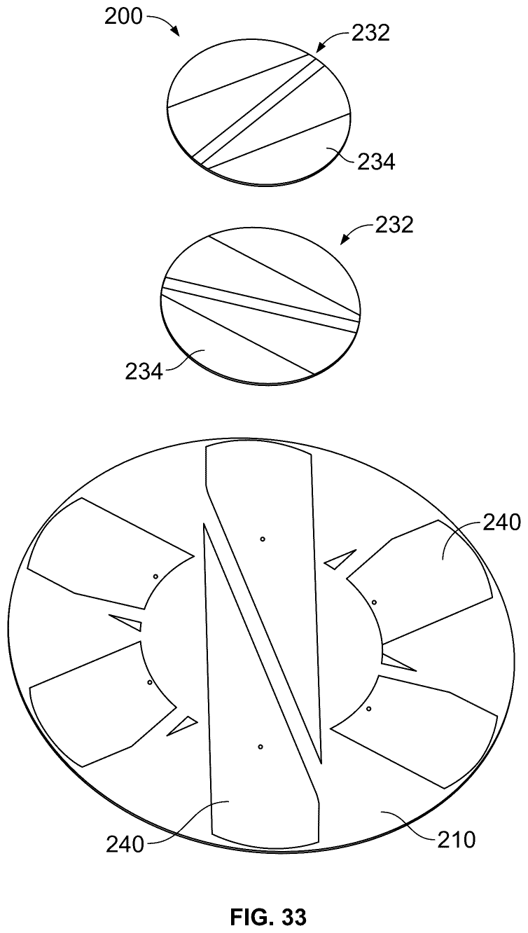

With additional reference to FIG. 32, which is a top perspective view of a portion of the antenna assembly 200 shown in FIG. 31, and FIG. 33, which is an exploded view of a portion of the antenna assembly 200 shown in FIG. 31, in an exemplary embodiment, the antenna assembly 200 includes multiple ground bridges 232 used to isolate the various ground elements 240. For example, the ground bridges 232 allow corresponding ground elements 240 to span over and across other ground elements 240. The dielectric substrates 234 of the ground bridges 232 electrically isolate the segments of the ground elements 240c from the other ground elements 240. In various embodiments, the ground elements can be isolated at the top layer but shorted to bottom layer ground via the PTH depending on the needs of DC isolation from the metal base.

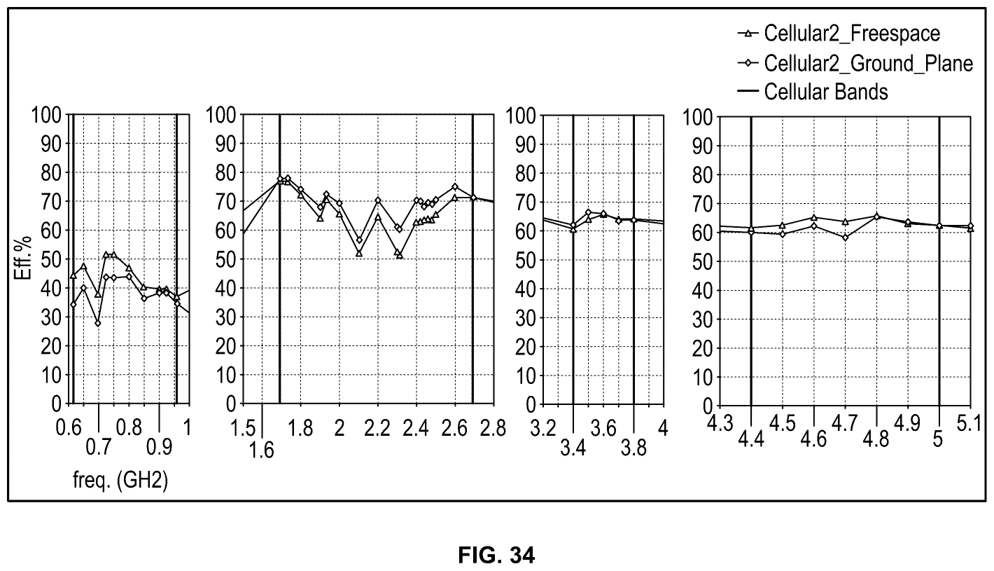

FIG. 34 is a chart showing efficiency performance summary of the cellular antenna elements of the antenna assembly 200 (for example, shown in FIGS. 18-19). The antenna assembly 200 is a multiband antenna having antenna elements and independent ground planes designed to operate and maintain performance when mounted on different structures, such as being mounted to a metal structure in a first confirmation (FIG. 1) and a non-metal structure in a second configuration (FIG. 2). The antenna assembly 200 is designed to avoid significant frequency detuning in both mounting configurations, particularly in the low frequency band (for example, 617 MHz-960 MHz). In the illustrated embodiment, the antenna assembly 200 has less than 10% drop/gain in efficiency between the different mounting configurations (metal vs. non-metal). The results shown in FIG. 34 are provided for purposes of illustration and not for purposes of limitation. Alternative embodiments of the antenna may be configured differently and have different operational or performance parameters than what is shown in FIG. 34.

In the illustrated embodiment, the antenna assembly 200 covers multiple cellular frequency bands, such as the 617-960 MHz band, the 1.7-2.7 GHz band, the 3.4-3.8 GHz band, and the 4.4-5 GHz band. In the low band (617-960 MHz band), the antenna assembly 200 has an average efficiency of approximately 40% with a loss in efficiency of less than 10% average in the metal mounting configuration. The other ranges have better average efficiency and significantly less loss in efficiency.

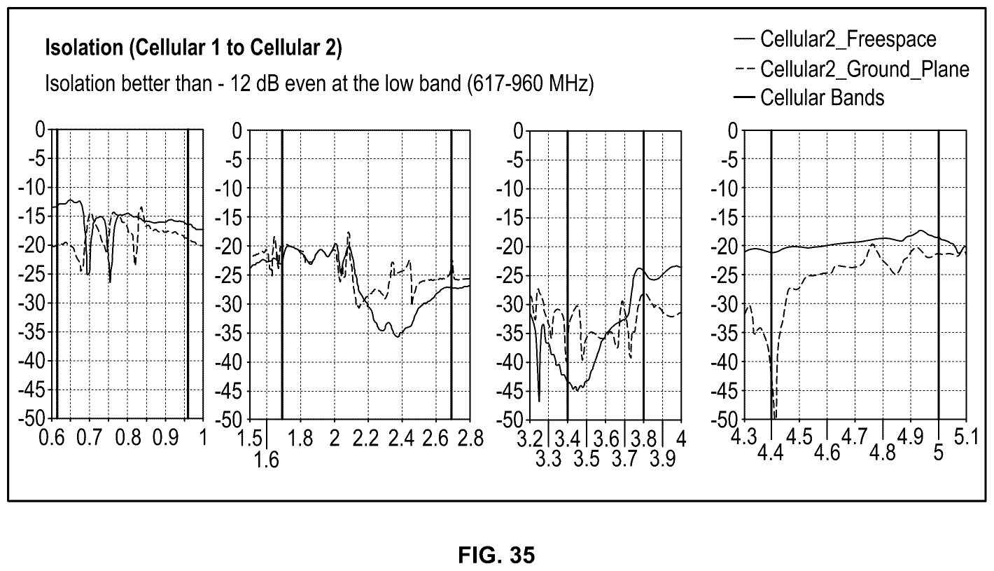

FIG. 35 is a chart showing isolation between the first and second cellular antennas of the antenna assembly 200 (for example, shown in FIGS. 18-19) in the different mounting configurations. The isolation is better than-10 dB in all frequency bands. For example, the isolation is less than −12 dB even in the low band (617 MHz-960 MHz). The results shown in FIG. 35 are provided for purposes of illustration and not for purposes of limitation. Alternative embodiments of the antenna may be configured differently and have different operational or performance parameters than what is shown in FIG. 35.

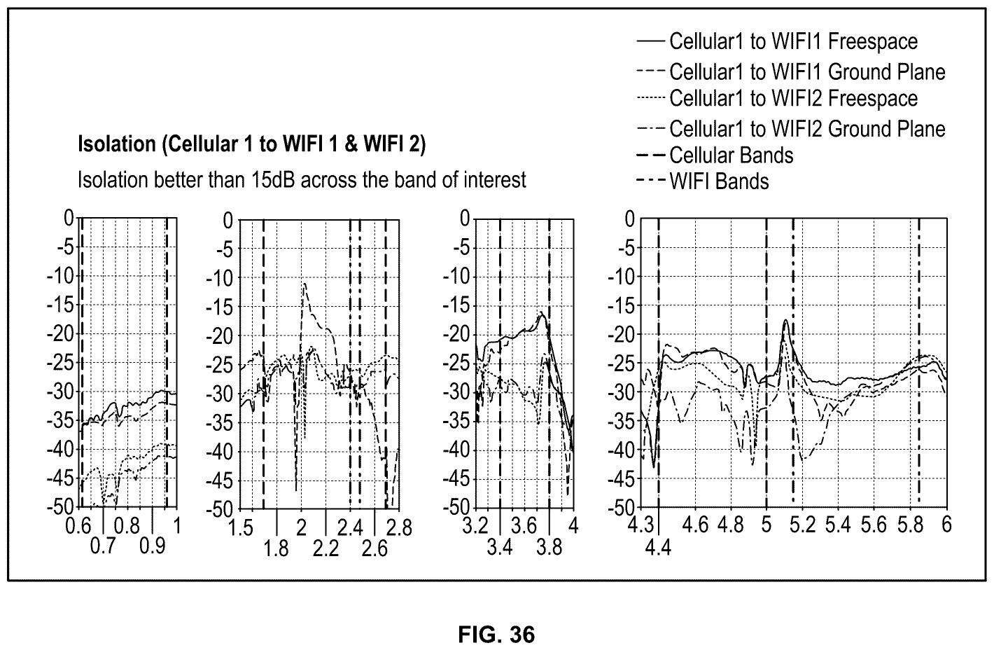

FIG. 36 is a chart showing isolation between the first cellular antenna and the first and second Wi-Fi antennas of the antenna assembly 200 (for example, shown in FIGS. 18-19) in the different mounting configurations. The isolation is better than-10 dB in all frequency bands. The results shown in FIG. 36 are provided for purposes of illustration and not for purposes of limitation. Alternative embodiments of the antenna may be configured differently and have different operational or performance parameters than what is shown in FIG. 36.

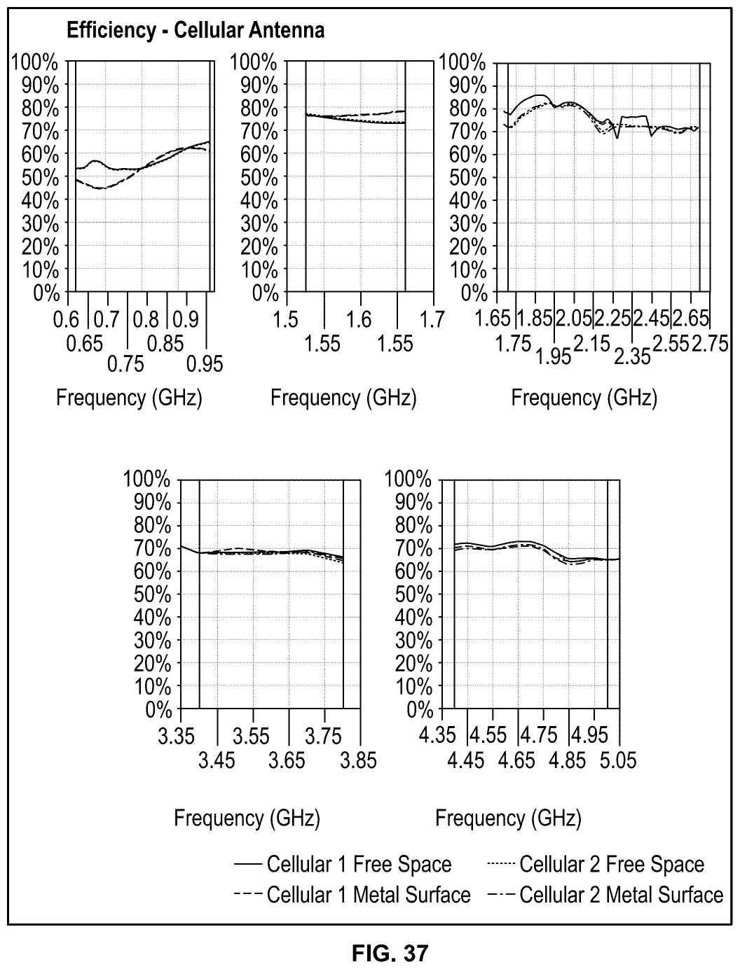

FIG. 37 is a chart showing efficiency performance summary of the cellular antenna elements of the antenna assembly 200 (for example, shown in FIGS. 21-23). The antenna assembly 200 is a multiband antenna having antenna elements and independent ground planes designed to operate and maintain performance when mounted on different structures, such as being mounted to a metal structure in a first confirmation (FIG. 1) and a non-metal structure in a second configuration (FIG. 2). The antenna assembly 200 is designed to avoid significant frequency detuning in both mounting configurations, particularly in the low frequency band (for example, 617 MHz-960 MHz). In the illustrated embodiment, the antenna assembly 200 has less than 10% drop/gain in efficiency between the different mounting configurations (metal vs. non-metal). The results shown in FIG. 37 are provided for purposes of illustration and not for purposes of limitation. Alternative embodiments of the antenna may be configured differently and have different operational or performance parameters than what is shown in FIG. 37.

In the illustrated embodiment, the antenna assembly 200 covers multiple cellular frequency bands, such as the 617-960 MHz band, the 1.53-1.66 GHz band, the 1.7-2.7 GHz band, the 3.4-3.8 GHz band, and the 4.4-5 GHz band. In the low band (617-960 MHz band), the antenna assembly 200 has an average efficiency of approximately 50% with a loss in efficiency of less than 5% average in the metal mounting configuration. The other ranges have better average efficiency and significantly less loss in efficiency.

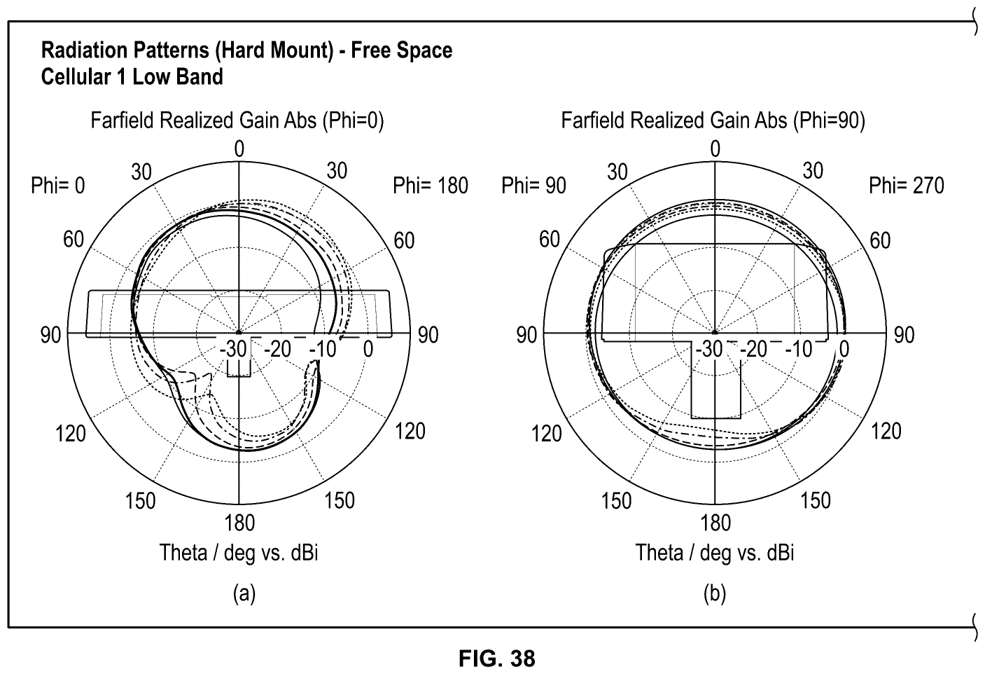

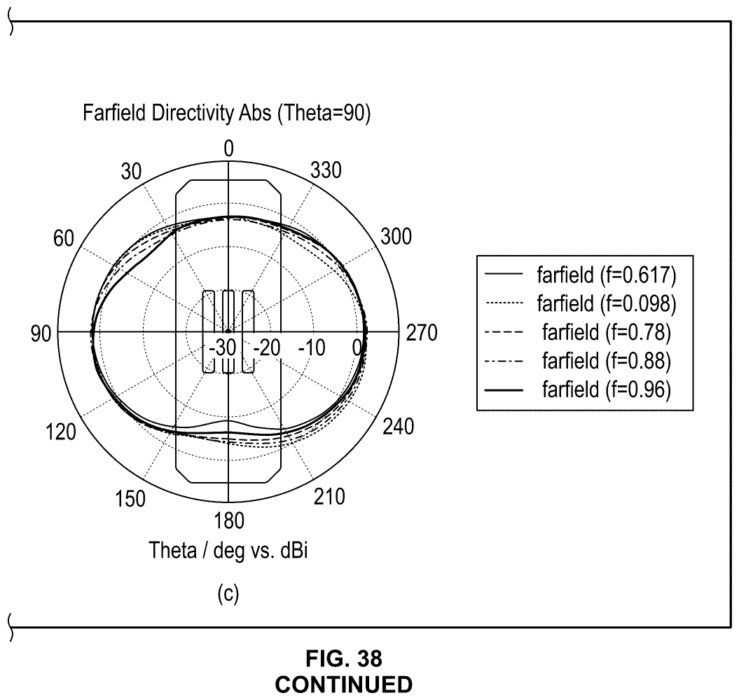

FIG. 38 shows the antenna radiation patterns at the low band for the antenna assembly 200 shown in FIGS. 21-23 in the non-metal mounting configuration. The results shown in FIG. 38 are provided for purposes of illustration and not for purposes of limitation. Alternative embodiments of the antenna may be configured differently and have different operational or performance parameters than what is shown in FIG. 38.

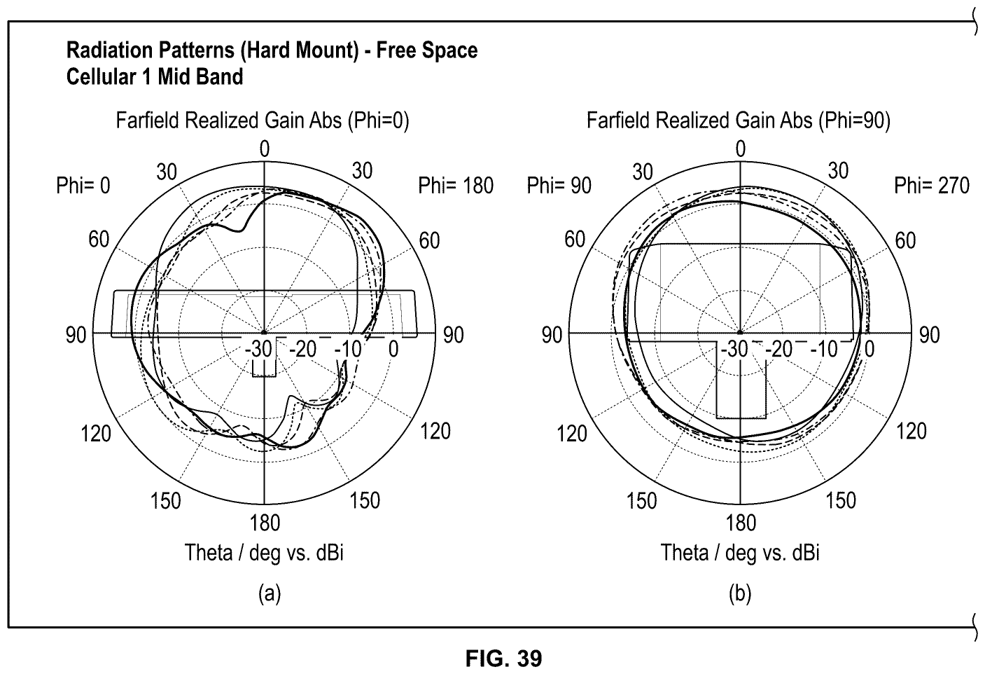

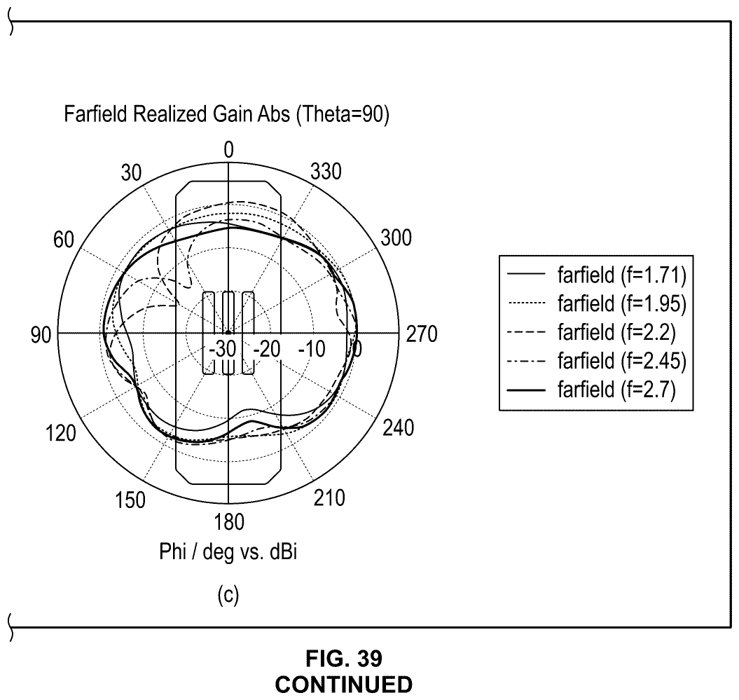

FIG. 39 shows the antenna radiation patterns at the mid band for the antenna assembly 200 shown in FIGS. 21-23 in the non-metal mounting configuration. The results shown in FIG. 39 are provided for purposes of illustration and not for purposes of limitation. Alternative embodiments of the antenna may be configured differently and have different operational or performance parameters than what is shown in FIG. 39.

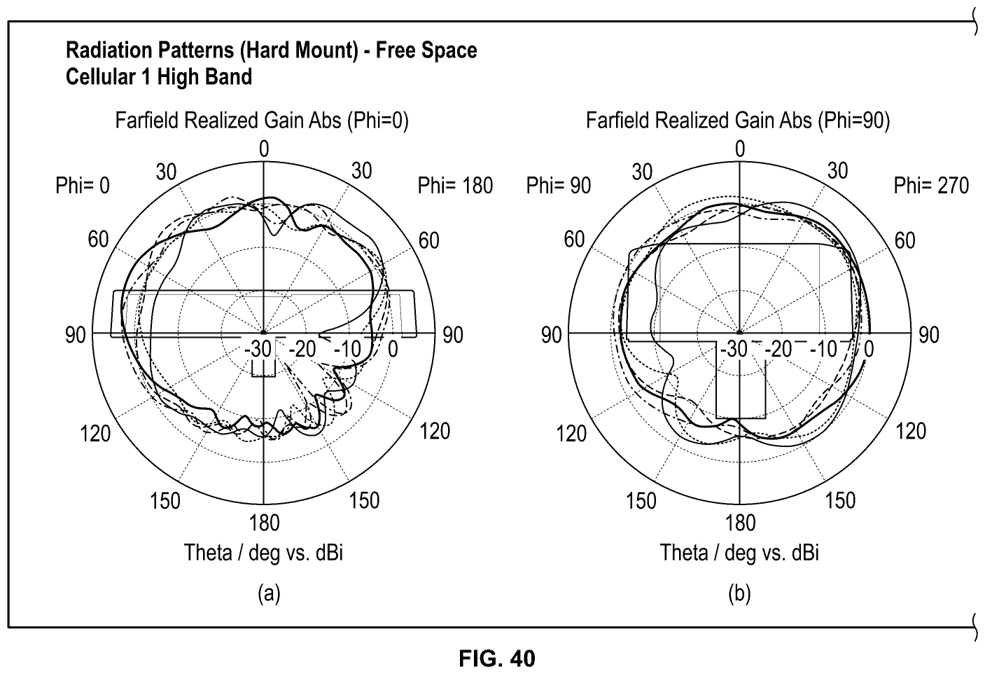

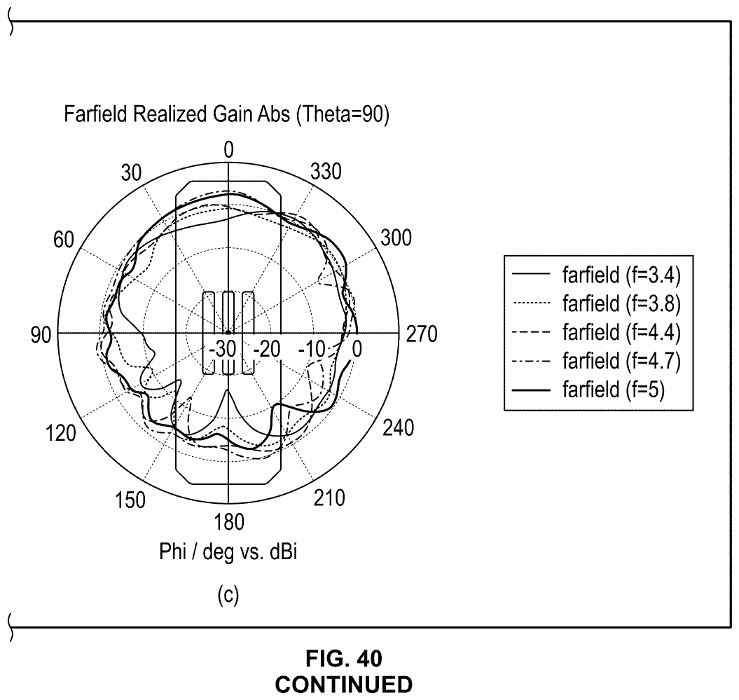

FIG. 40 shows the antenna radiation patterns at the high band for the antenna assembly 200 shown in FIGS. 21-23 in the non-metal mounting configuration. The results shown in FIG. 40 are provided for purposes of illustration and not for purposes of limitation. Alternative embodiments of the antenna may be configured differently and have different operational or performance parameters than what is shown in FIG. 40.

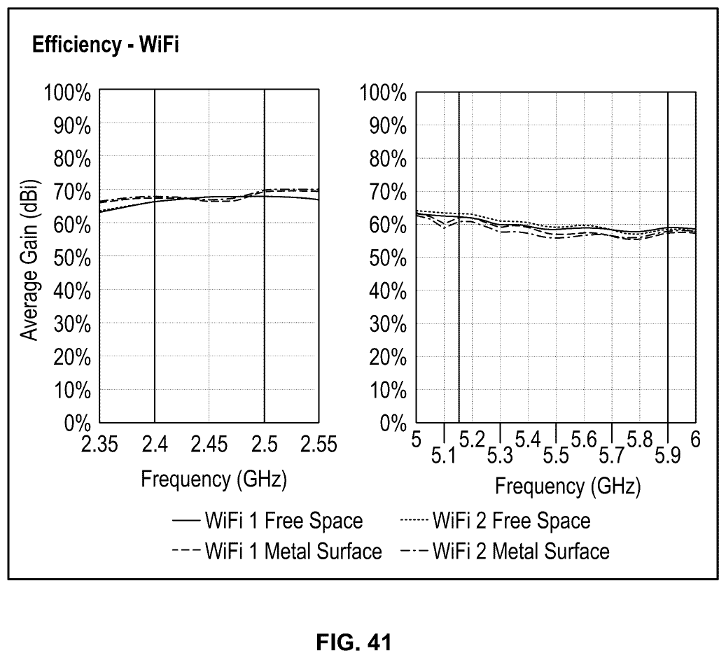

FIG. 41 is a chart showing efficiency performance summary of the Wi-Fi antenna elements of the antenna assembly 200 (for example, shown in FIGS. 21-23). In the illustrated embodiment, the Wi-Fi elements cover multiple Wi-Fi frequency bands, such as the 2.4-2.5 GHz band and the 5.1-5.9 GHz band. The antenna assembly 200 has an average efficiency of greater than 60% with a loss in efficiency of less than 5% average in the conductive mounting configuration. The results shown in FIG. 41 are provided for purposes of illustration and not for purposes of limitation. Alternative embodiments of the antenna may be configured differently and have different operational or performance parameters than what is shown in FIG. 41.

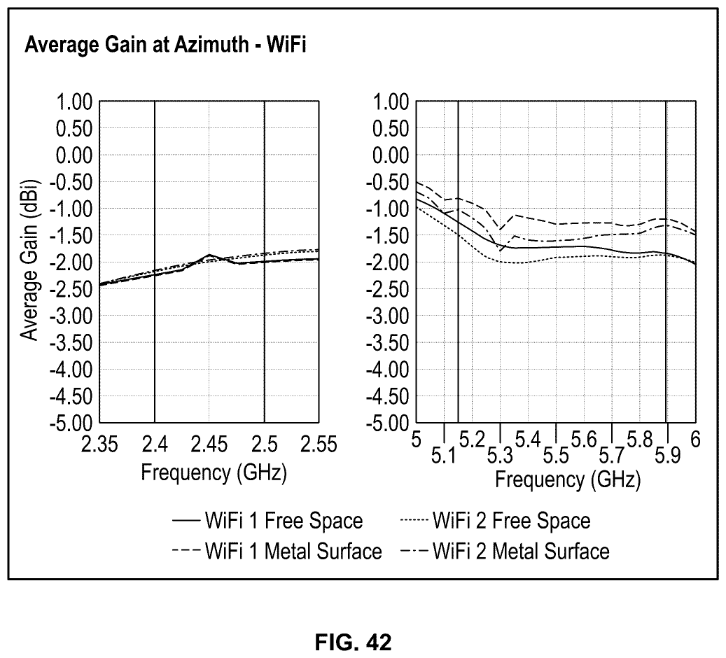

FIG. 42 is a chart showing average gain at Azimuth of the Wi-Fi antenna elements of the antenna assembly 200 (for example, shown in FIGS. 21-23). In the illustrated embodiment, the Wi-Fi elements cover multiple Wi-Fi frequency bands, such as the 2.4-2.5 GHz band and the 5.1-5.9 GHz band. The antenna assembly 200 has average gain differences of less than 0.5 dB between the metal and non-metal mounting configurations. The results shown in FIG. 42 are provided for purposes of illustration and not for purposes of limitation. Alternative embodiments of the antenna may be configured differently and have different operational or performance parameters than what is shown in FIG. 42.

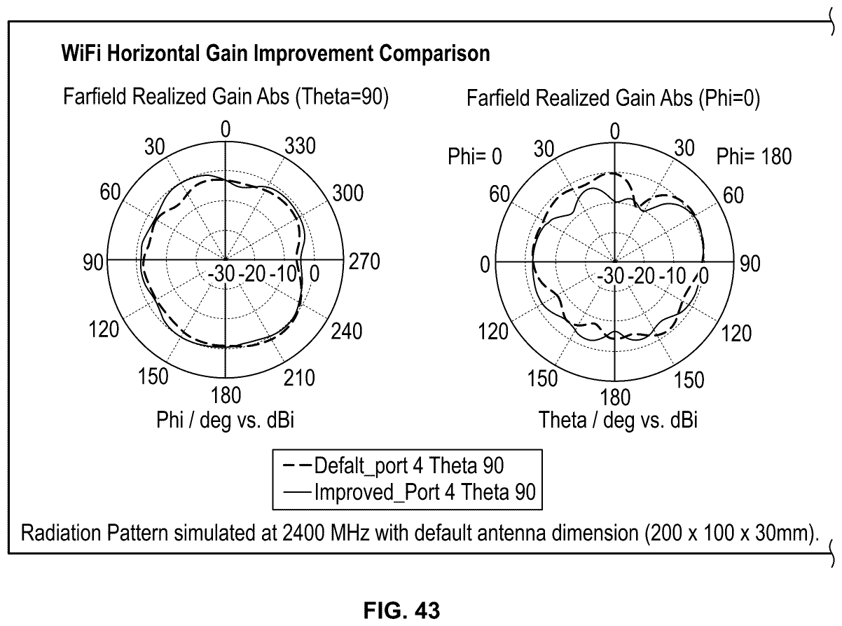

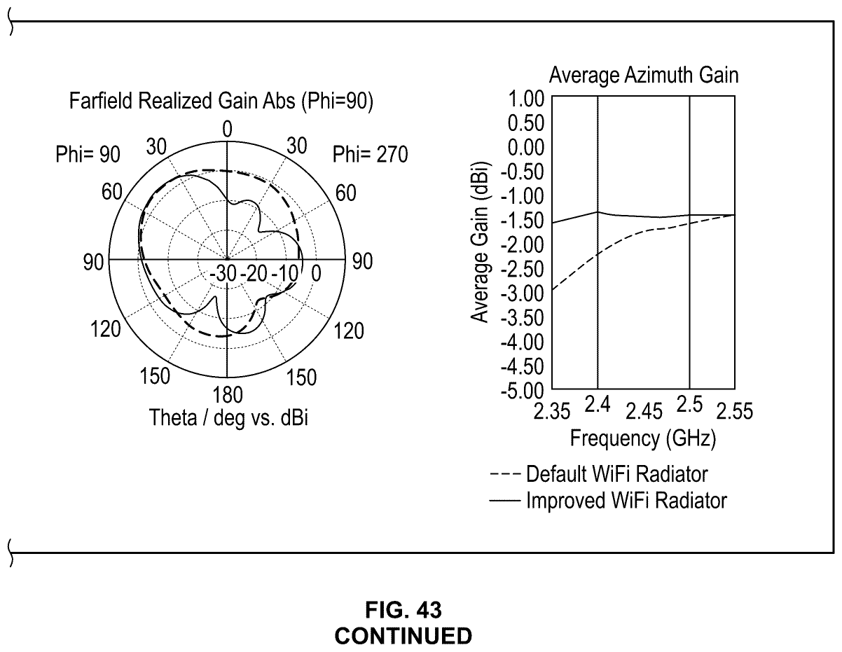

FIG. 43 shows the antenna radiation patterns of the Wi-Fi antenna elements of the antenna assembly 200 (for example, shown in FIGS. 21-23). The results shown in FIG. 43 are provided for purposes of illustration and not for purposes of limitation. Alternative embodiments of the antenna may be configured differently and have different operational or performance parameters than what is shown in FIG. 43.

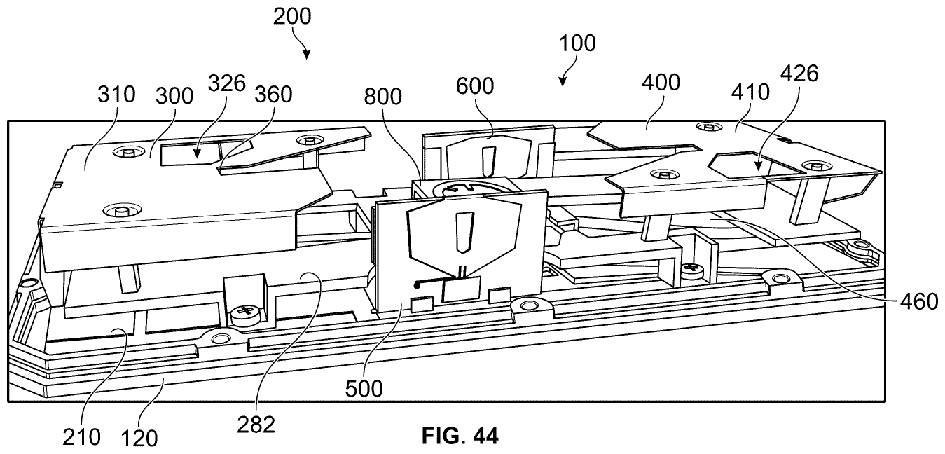

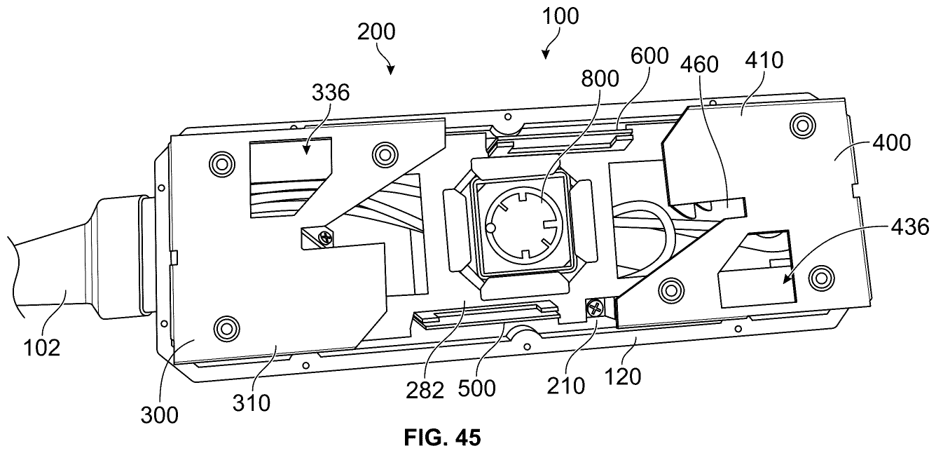

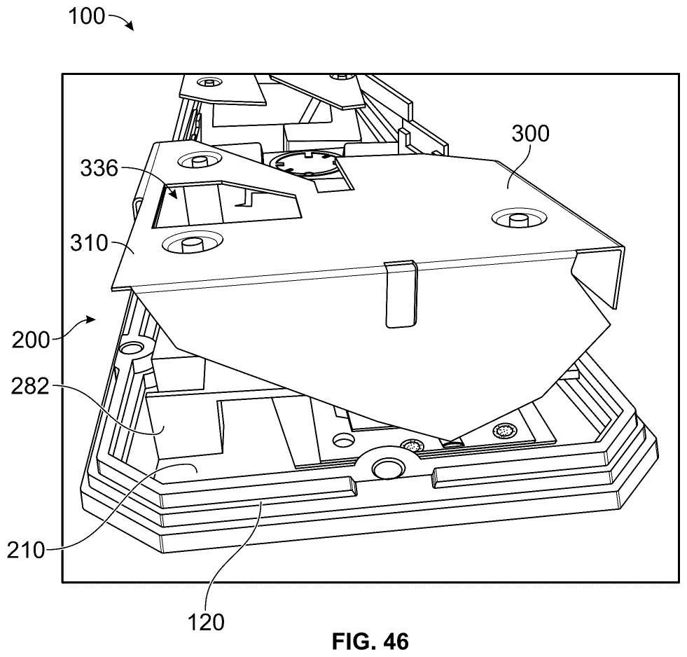

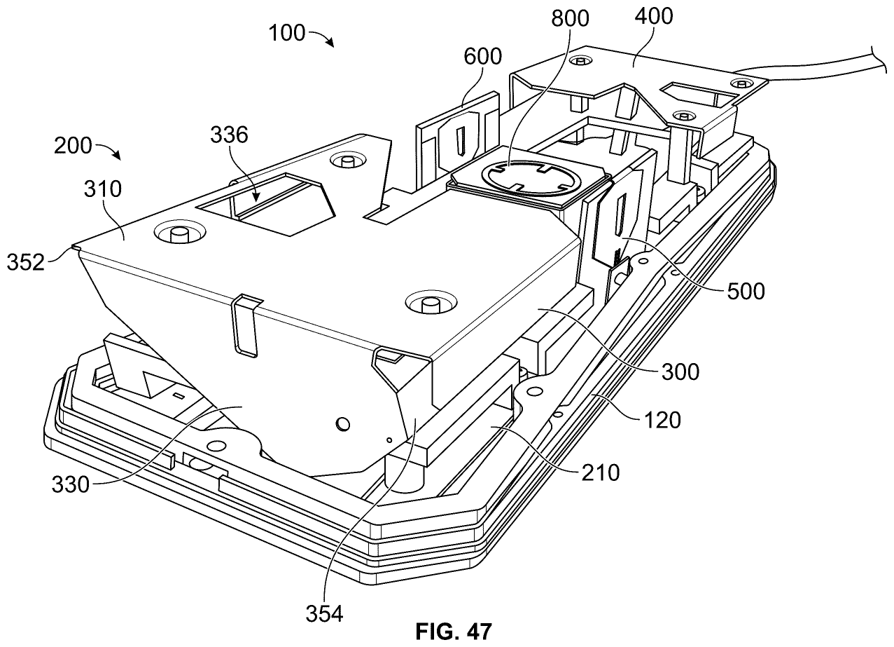

FIG. 44 is a side view of a portion of the vehicular antenna 100 in accordance with an exemplary embodiment. FIG. 45 is a top view of a portion of the vehicular antenna 100 in accordance with an exemplary embodiment. FIG. 46 is an end view of a portion of the vehicular antenna 100 in accordance with an exemplary embodiment. FIG. 47 is a perspective view of a portion of the vehicular antenna 100 in accordance with an exemplary embodiment.

In an exemplary embodiment, the antenna assembly 200 includes the first cellular antenna 300, the second cellular antenna 400, the first Wi-Fi antenna 500, the second Wi-Fi antenna 600, which may be a combined antenna element combined with a Bluetooth antenna, and the GNSS antenna 800. In an exemplary embodiment, the first and second cellular antennas 300, 400 include openings 326, 426 in the patch panels 310, 410. The openings 326, 426 provide visibility and/or access to the shorting pins 360, 460, such as for soldering. FIG. 45 shows the feed cable 102 exiting from the side of the antenna assembly 200, such as for adhesive mounting of the base 120.

In an exemplary embodiment, the cellular antenna 300 includes a connecting element 354 (FIG. 47) between the side wall 350 and/or the side wall 352 and the feed panel 330. The connecting element 354 may be a weld joint. The connecting element 354 may be a stamped component from the feed panel 330 or the side wall 350. The connecting element 354 may be a wire or other conductor between the side wall 350 and the feed panel 330. The connecting element 354 may improve the cellular performance by connecting the side wall 350 to the feed panel 330.

In an exemplary embodiment, the antenna assembly 200 includes a plastic carrier 282 for holding the antenna elements in place relative to each other and/or relative to the substrate 210. The plastic carrier 282 may protect the antenna elements from drop and vibration. The antenna elements may be secured to the plastic carrier 282 by heat stakes, fasteners, clips, adhesive, and the like. Optionally multiple plastic carriers may be provided, such as for the different antenna elements. The plastic carrier may be mounted to the substrate 210 and/or the base 120.

Further, the disclosure comprises examples according to the following clauses:
Clause 1. A vehicular antenna comprising:
a low-profile housing having a first end and a second end, the low-profile housing having a first side and a second side; and
an antenna assembly in the low-profile housing, the antenna assembly including a first cellular antenna at the first end and a second cellular antenna at the second end, the antenna assembly including a first ground element at the first side and a second ground element at the second side, the first cellular antenna operably coupled to the first ground element, the second cellular antenna operably coupled to the second ground element, the first ground element isolated from the second ground element.
Clause 2. The vehicular antenna of clause 1, wherein the antenna assembly further includes a GNSS antenna, a first Wi-Fi antenna at the first side between the first and second cellular antennas, a second Wi-Fi antenna at the second side between the first and second cellular antennas, and a Bluetooth antenna at the second side between the first and second cellular antennas.
Clause 3. The vehicular antenna of any of clauses 1-2, wherein the first ground element includes a first substrate supporting a first upper ground plane and a first lower ground plane with a single plated through hole connecting the first upper ground plane and the first lower ground plane, and wherein the second ground element includes a second substrate supporting a second upper ground plane and a second lower ground plane with a single plated through hole connecting the second upper ground plane and the second lower ground plane.
Clause 4. The vehicular antenna of any of clauses 1-3, wherein the first ground element is triangular shaped being wider at the first end and narrower at the second end, and wherein the second ground element is triangular shaped being wider at the second end and narrower at the first end.
Clause 5. The vehicular antenna of any of clauses 1-4, wherein the first cellular antenna includes a first patch panel and a first tapered feed between the first patch panel and the first ground element, and wherein the second cellular antenna includes a second patch panel and a second tapered feed between the second patch panel and the second ground element.
Clause 6. The vehicular antenna of clause 5, wherein the tapered feed is asymmetrical and the second tapered feed is asymmetrical.
Clause 7. The vehicular antenna of any of clauses 5-6, wherein the first cellular antenna includes extended side walls extending from opposite sides of the first patch panel toward the first ground element, and wherein the second cellular antenna includes extended side walls extending from opposite sides of the second patch panel toward the second ground element.
Clause 8. The vehicular antenna of any of clauses 5-7, wherein the first cellular antenna includes a first shorting pin extending between the first patch panel and the first ground element, and wherein the second cellular antenna includes a second shorting pin extending between the second patch panel and the second ground element.
Clause 9. The vehicular antenna of any of clauses 5-8, wherein the first patch panel includes a first slot, the first patch panel being asymmetrical on opposite sides of the first slot, and wherein the second patch panel includes a second slot, the second patch panel being asymmetrical on opposite sides of the second slot.
Clause 10. The vehicular antenna of any of clauses 5-9, wherein the first tapered feed is coupled to a feed element via a matching circuit, and wherein the second tapered feed is coupled to a feed element via a matching circuit.
Clause 11. The vehicular antenna of any of clauses 5-10, wherein the first tapered feed includes a first tapered edge, the first tapered edge having a cut-back to increase an edge length of the first tapered edge, and wherein the second tapered feed includes a second tapered edge, the second tapered edge having a cut-back to increase an edge length of the second tapered feed.
Clause 12. The vehicular antenna of any of clauses 1-11, wherein the housing includes a metal base, the first and second ground elements being electrically connected to the conductive base.
Clause 13. The vehicular antenna of any of clauses 1-12, wherein the housing includes a base and a radome coupled to the base, the radome having a low-profile height.
Clause 14. The vehicular antenna of clause 13, wherein the base has a footprint having a length at most 200 mm and a width at most 100 mm.
Clause 15. The vehicular antenna of any of clauses 13-14, wherein the base includes a threaded mount configured to be threadably coupled to a structure of the vehicle.
Clause 16. The vehicular antenna of any of clauses 13-15, wherein the base includes an adhesive layer at a bottom configured to be adhesively applied to a structure of the vehicle.
Clause 17. The vehicular antenna of any of clauses 1-16, further comprising a feed cable extending from a bottom of the housing.
Clause 18. The vehicular antenna of any of clauses 1-17, further comprising a feed cable extending from one of the first end or the first side of the housing.
Clause 19. The vehicular antenna of any of clauses 1-18, wherein the antenna assembly includes a Wi-Fi antenna at the first side positioned between the first and second cellular antennas, the Wi-Fi antenna oriented vertically and facing the first side.
Clause 20. The vehicular antenna of clause 19, wherein the antenna assembly includes a second Wi-Fi antenna at the second side positioned between the first and second cellular antennas, the Wi-Fi antenna oriented vertically and facing the second side, wherein the first and second Wi-Fi antennas being offset relative to the first and second ends.
Clause 21. The vehicular antenna of any of clauses 19-20, wherein the Wi-Fi antenna includes a parasitic radiating element for azimuth gain improvement.
Clause 22. The vehicular antenna of any of clauses 19-21, wherein the Wi-Fi antenna includes a suspended ground plane independent of the first and second ground elements.
Clause 23. The vehicular antenna of any of clauses 19-22, wherein the Wi-Fi antenna includes a PCB having a Wi-Fi antenna element, a suspended ground plane, a Wi-Fi feed coupled to the antenna element, and a shorting trace between the Wi-Fi feed and the suspended ground plane.
Clause 24. The vehicular antenna of any of clauses 19-23, wherein the Wi-Fi antenna includes a series capacitor for high band impedance.
Clause 25. The vehicular antenna of any of clauses 19-24, wherein the Wi-Fi antenna includes a shunt resistor.
Clause 26. The vehicular antenna of any of clauses 1-25, wherein the antenna assembly includes a third cellular antenna and a fourth cellular antenna, the antenna assembly including a third ground element and a fourth ground element, the third cellular antenna operably coupled to the third ground element, the fourth cellular antenna operably coupled to the fourth ground element, the third ground element isolated from the fourth ground element.
Clause 27. The vehicular antenna of claim 26, wherein the third cellular antenna is at the first side and the fourth cellular antenna is at the second side.
Clause 28. The vehicular antenna of any of clauses 26-27, wherein the antenna assembly includes a ground bridge allowing the third and fourth ground elements to span over the first and second ground elements, the ground bridge electrically isolating the third and fourth ground elements from the first and second ground elements.
Clause 29. The vehicular antenna of any of clauses 26-28, wherein the first and second cellular antennas are arranged in a first antenna group at the first end and the third and fourth cellular antennas are arranged in a second antenna group at the second end.
Clause 30. The vehicular antenna of any of clauses 26-29, wherein the antenna assembly includes a fifth cellular antenna and a sixth cellular antenna, the antenna assembly including a fifth ground element and a sixth ground element, the fifth cellular antenna operably coupled to the fifth ground element, the sixth cellular antenna operably coupled to the sixth ground element, the fifth ground element isolated from the sixth ground element.
Clause 31. The vehicular antenna of clause 30, wherein the housing is circular, the first through sixth antenna elements being circumferentially spaced apart around a perimeter of the housing.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S. C. § 112(f), unless and until such claim limitations expressly use the phrase “means for” followed by a statement of function void of further structure.

What is claimed is:

1. A vehicular antenna comprising:
a low-profile housing having a first end and a second end, the low-profile housing having a first side and a second side; and
an antenna assembly in the low-profile housing, the antenna assembly including a first cellular antenna at the first end and a second cellular antenna at the second end, the antenna assembly including a first ground element at the first side and a second ground element at the second side, the first cellular antenna operably coupled to the first ground element, the second cellular antenna operably coupled to the second ground element, the first ground element isolated form the second ground element.

2. The vehicular antenna of claim 1, wherein the antenna assembly further includes a GNSS antenna, a first Wi-Fi antenna at the first side between the first and second cellular antennas, a second Wi-Fi antenna at the second side between the first and second cellular antennas, and a Bluetooth antenna at the second side between the first and second cellular antennas.

3. The vehicular antenna of claim 1, wherein the first ground element includes a first substrate supporting a first upper ground plane and a first lower ground plane with a single plated through hole connecting the first upper ground plane and the first lower ground plane, and wherein the second ground element includes a second substrate supporting a second upper ground plane and a second lower ground plane with a single plated through hole connecting the second upper ground plane and the second lower ground plane.

4. The vehicular antenna of claim 1, wherein the first ground element is triangular shaped being wider at the first end and narrower at the second end, and wherein the second ground element is triangular shaped being wider at the second end and narrower at the first end.

5. The vehicular antenna of claim 1, wherein the first cellular antenna includes a first patch panel and a first tapered feed between the first patch panel and the first ground element, and wherein the second cellular antenna includes a second patch panel and a second tapered feed between the second patch panel and the second ground element.

6. The vehicular antenna of claim 5, wherein the first tapered feed is asymmetrical and the second tapered feed is asymmetrical.

7. The vehicular antenna of claim 5, wherein the first cellular antenna includes extended side walls extending from opposite sides of the first patch panel toward the first ground element, and wherein the second cellular antenna includes extended side walls extending from opposite sides of the second patch panel toward the second ground element.

8. The vehicular antenna of claim 5, wherein the first cellular antenna includes a first shorting pin extending between the first patch panel and the first ground element, and wherein the second cellular antenna includes a second shorting pin extending between the second patch panel and the second ground element.

9. The vehicular antenna of claim 5, wherein the first patch panel includes a first slot, the first patch panel being asymmetrical on opposite sides of the first slot, and wherein the second patch panel includes a second slot, the second patch panel being asymmetrical on opposite sides of the second slot.

10. The vehicular antenna of claim 5, wherein the first tapered feed is coupled to a feed element via a matching circuit, and wherein the second tapered feed is coupled to a feed element via a matching circuit.

11. The vehicular antenna of claim 5, wherein the first tapered feed includes a first tapered edge, the first tapered edge having a cut-back to increase an edge length of the first tapered edge, and wherein the second tapered feed includes a second tapered edge, the second tapered edge having a cut-back to increase an edge length of the second tapered feed.

12. The vehicular antenna of claim 1, wherein the housing includes a conductive base, the first and second ground elements being electrically connected to the metal base.

13. The vehicular antenna of claim 1, wherein the housing includes a base and a radome coupled to the base, the radome having a low-profile height.

14. The vehicular antenna of claim 1, further comprising a feed cable extending from a bottom of the housing.

15. The vehicular antenna of claim 1, further comprising a feed cable extending from one of the first end or the first side of the housing.

16. The vehicular antenna of claim 1, wherein the antenna assembly includes a Wi-Fi antenna at the first side positioned between the first and second cellular antennas, the Wi-Fi antenna oriented vertically and facing the first side.

17. The vehicular antenna of claim 1, wherein the antenna assembly includes a third cellular antenna and a fourth cellular antenna, the antenna assembly including a third ground element and a fourth ground element, the third cellular antenna operably coupled to the third ground element, the fourth cellular antenna operably coupled to the fourth ground element, the third ground element isolated form the fourth ground element.

18. A vehicular antenna comprising:
a low-profile housing having a first end and a second end, the low-profile housing having a first side and a second side; and
an antenna assembly in the low-profile housing, the antenna assembly including a first cellular antenna at the first end, a second cellular antenna at the second end, a first ground element at the first side, and a second ground element at the second side,
the first cellular antenna including a first patch panel and a first tapered feed extending from the first patch panel, the first tapered feed being operably coupled to the first ground element;
the second cellular antenna including a second patch panel and a second tapered feed extending from the second patch panel, the second tapered feed being operably coupled to the second ground element;
the first ground element having a first tapered edge tapered between a first connecting end and a first distal end, the first connecting end located below the first patch panel and being operably coupled to the first tapered feed, the first distal end located below the second patch panel;
the second ground element having a second tapered edge tapered between a second connecting end and a second distal end, the second connecting end located below the second patch panel and being operably coupled to the second tapered feed, the second distal end located below the second patch panel;
wherein the first tapered edge faces the second tapered edge across a ground gap, the first ground element being isolated form the second ground element across the ground gap.

19. A vehicular antenna comprising:
a low-profile housing having a first end and a second end, the low-profile housing having a first side and a second side; and
an antenna assembly in the low-profile housing, the antenna assembly including a first cellular antenna at the first end, a second cellular antenna at the second end, a first Wi-Fi antenna at the first side between the first and second cellular antennas, a second Wi-Fi antenna at the second side between the first and second cellular antennas, and a Bluetooth antenna at the second side between the first and second cellular antennas;
the antenna assembly including a first ground element at the first side and a second ground element at the second side, the first cellular antenna operably coupled to the first ground element, the second cellular antenna operably coupled to the second ground element, the first ground element isolated form the second ground element.
